(19) United States
(12) Patent Application Publication
(10) Pub. No.: US 2006/0221384 A1
(43) Pub. Date: Oct. 5, 2006

(54) IMAGE FORMING APPARATUS, CONTROL METHOD THEREOF, AND IMAGE FORMING SYSTEM

(75) Inventor: HIROTOMO TANAKA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/276,984

(22) Filed: Mar. 20, 2006

(30) Foreign Application Priority Data
Mar. 31, 2005 (JP) 2005-104359

(51) Int. Cl. G06F 3/12

(52) U.S. Cl. 358/1.15

(57) ABSTRACT

In an image forming apparatus capable of receiving a job in a distributed print mode in which print processing is executed by distributing the print processing to a plurality of image forming apparatuses and a job in a single print mode in which print processing is executed by one image forming apparatus, job information about a received job is stored and managed. Output of information of the received jobs is controlled on the basis of the stored job information so as to make the information distinguishable between the job in the distributed print mode and the job in the single print mode.

### FIELD OF THE INVENTION

The present invention relates to an image forming apparatus capable of receiving a job in a distributed print mode in which print processing is executed by distributing the print processing to a plurality of image forming apparatuses and a job in a single print mode in which print processing is executed by one image forming apparatus, a control method thereof, and an image forming system.

### BACKGROUND OF THE INVENTION

Conventionally, a cluster print technique is used to process a mass of print jobs by using image forming apparatuses. In the cluster print technique, instead of processing a mass of print jobs by one image forming apparatus, one print job is divisionally issued to a plurality of image forming apparatuses. Hence, a printed product can be obtained more quickly than processing by a single apparatus (e.g., Japanese Patent Laid-Open No. 2000-112702). In Japanese Patent Laid-Open No. 2000-112702, a print job can be divided variously depending on, e.g., the number of copies, pages, or page colors.

In the above-described prior art, however, the operator must go to an image forming apparatus of an output destination in order to pick up a divisionally processed printed product. When the operator is doing the operation at a specific image forming apparatus, he/she cannot confirm the end result or state of print processing divisionally issued to other image forming apparatuses. That is, the operator must walk between the plurality of image forming apparatuses to periodically confirm the state of print processing so that the load on the user is heavy. In addition, the operation cannot efficiently be executed.

### SUMMARY OF THE INVENTION

The present invention has been made to solve the above-described problems, and has as its object to provide an image forming apparatus capable of improving the operation efficiency in a distributed print environment, a control method thereof, and an image forming system.

According to the present invention, the foregoing object is attained by providing an image forming apparatus capable of receiving a job in a distributed print mode in which print processing is executed by distributing the print processing to a plurality of image forming apparatuses and a job in a single print mode in which print processing is executed by one image forming apparatus, comprising:

storage means for storing and managing job information about a received job; and

output control means for controlling output of information of the received jobs on the basis of the job information stored in the storage means so as to make the information distinguishable between the job in the distributed print mode and the job in the single print mode.

In a preferred embodiment, the output control means outputs, to a display unit, the information of the received jobs on the basis of the job information stored in the storage means so as to make the information distinguishable between the job in the distributed print mode and the job in the single print mode.

In a preferred embodiment, the output control means outputs, to a display unit, a list of the information of the received jobs on the basis of the job information stored in the storage means so as to make the information distinguishable between the job in the distributed print mode and the job in the single print mode.

In a preferred embodiment, the output control means outputs, to a single window displayed on a display unit, the information of the received jobs on the basis of the job information stored in the storage means so as to make the information distinguishable between the job in the distributed print mode and the job in the single print mode.

In a preferred embodiment, the output control means has

a first output mode in which, of the received jobs, information of only the job in the single print mode is output on the basis of the job information stored in the storage means;

a second output mode in which, of the received jobs, information of only the job in the distributed print mode is output on the basis of the job information stored in the storage means; and

a third output mode in which, of the received jobs, pieces of information of the jobs in the single print mode and distributed print mode are output distinguishably on the basis of the job information stored in the storage means.

In a preferred embodiment, the apparatus further comprises instruction means for instructing output in the first output mode, the second output mode, and the third output mode.

In a preferred embodiment, the apparatus further comprises execution means for executing, in accordance with designated processing contents, processing of a job selected on the basis of the job information output by the output control means.

In a preferred embodiment, the execution means executes, on the basis of selected processing contents, one of

cancel processing of canceling a processing operation of the selected job,

priority processing of giving a priority to processing of the selected job over remaining jobs, and

authentication processing of executing the processing of the selected job on the basis of authentication.

In a preferred embodiment, the apparatus further comprises selection means for selecting the job as an execution target by the execution means and the processing contents.

In a preferred embodiment, when the job as the execution target by the execution means is the job in the distributed print mode, the selection means is capable of selecting whether to perform execution by the execution means for each of the image forming apparatuses of a distribution source and distribution destination of the job.

In a preferred embodiment, the selection means is capable of selecting, for the job in the distributed print mode, one of

a first selection mode in which only the image forming apparatus of the distribution source of the job is selected as the execution target by the execution means,

a second selection mode in which only the image forming apparatus of the distribution destination of the job is selected as the execution target by the execution means,

a third selection mode in which all the image forming apparatuses of the distribution source and distribution destination of the job are selected as the execution target by the execution means, and

a fourth selection mode in which an image forming apparatus to process a desired one of a plurality of partial jobs included in the job is selected as the execution target by the execution means.

According to the present invention, the foregoing object is attained by providing an image forming apparatus capable of receiving a job in a distributed print mode in which print processing is executed by distributing the print processing to a plurality of image forming apparatuses and a job in a single print mode in which print processing is executed by one image forming apparatus, comprising:

storage means for storing and managing job information about a received job; and

execution means for executing, in accordance with designated processing contents, processing of a job selected on the basis of the job information stored in the storage means,

the execution means comprising, for the job in the distributed print mode,

a first selection mode in which only the image forming apparatus of a distribution source of the job is selected as an execution target by the execution means,

a second selection mode in which only the image forming apparatus of a distribution destination of the job is selected as the execution target by the execution means,

a third selection mode in which all the image forming apparatuses of the distribution source and distribution destination of the job are selected as the execution target by the execution means, and

a fourth selection mode in which an image forming apparatus to process a desired one of a plurality of partial jobs included in the job is selected as the execution target by the execution means.

In a preferred embodiment, the execution means executes, on the basis of selected processing contents, one of

cancel processing of canceling a processing operation of the selected job,

priority processing of giving a priority to processing of the selected job over remaining jobs, and

authentication processing of executing the processing of the selected job on the basis of authentication.

In a preferred embodiment, the apparatus further comprises:

the plurality of image forming apparatuses and an external device, which are connected through a network;

reading means for reading a document; and

input means for receiving and inputting the job through one of the image forming apparatuses, the external device, and the reading means connected through the network.

According to the present invention, the foregoing object is attained by providing an image forming system formed by mutually connecting, through a network, a plurality of image forming apparatuses each capable of receiving a job in a distributed print mode in which print processing is executed by distributing the print processing to a plurality of image forming apparatuses and a job in a single print mode in which print processing is executed by one image forming apparatus, wherein

each of the image forming apparatuses comprises:

storage means for storing and managing job information about a received job;

output control means for controlling output of information of the received jobs on the basis of the job information stored in the storage means so as to make the information distinguishable between the job in the distributed print mode and the job in the single print mode; and

notification means for sending an update notification of the job information of the job between the image forming apparatuses of a distribution source and distribution destination of the job in the distributed print mode.

According to the present invention, the foregoing object is attained by providing an image forming system formed by mutually connecting, through a network, a plurality of image forming apparatuses each capable of receiving a job in a distributed print mode in which print processing is executed by distributing the print processing to a plurality of image forming apparatuses and a job in a single print mode in which print processing is executed by one image forming apparatus, wherein

each of the image forming apparatuses comprises;

storage means for storing and managing job information about a received job;

execution means for executing, in accordance with designated processing contents, processing of a job selected on the basis of the job information stored in the storage means; and

notification means for sending an update notification of the job information of the job between the image forming apparatuses of a distribution source and distribution destination of the job in the distributed print mode,

the execution means comprising, for the job in the distributed print mode,

a first selection mode in which only the image forming apparatus of the distribution source of the job is selected as an execution target by the execution means,

a second selection mode in which only the image forming apparatus of the distribution destination of the job is selected as the execution target by the execution means,

a third selection mode in which all the image forming apparatuses of the distribution source and distribution destination of the job are selected as the execution target by the execution means, and

a fourth selection mode in which an image forming apparatus to process a desired one of a plurality of partial jobs included in the job is selected as the execution target by the execution means.

According to the present invention, the foregoing object is attained by providing a control method of an image forming apparatus capable of receiving a job in a distributed print mode in which print processing is executed by distributing the print processing to a plurality of image forming apparatuses and a job in a single print mode in which print processing is executed by one image forming apparatus, comprising:

a storage step of storing job information about a received job in a storage unit to store and manage the job information; and

an output control step of controlling output of information of the received jobs on the basis of the job information stored in the storage unit so as to make the information distinguishable between the job in the distributed print mode and the job in the single print mode.

According to the present invention, the foregoing object is attained by providing a control method of an image forming apparatus capable of receiving a job in a distributed print mode in which print processing is executed by distributing the print processing to a plurality of image forming apparatuses and a job in a single print mode in which print processing is executed by one image forming apparatus, comprising:

a storage step of storing job information about a received job in a storage unit to store and manage the job information; and

an execution step of executing, in accordance with designated processing contents, processing of a job selected on the basis of the job information stored in the storage unit,

the execution step comprising, for the job in the distributed print mode,

a first selection mode in which only the image forming apparatus of a distribution source of the job is selected as an execution target in the execution step,

a second selection mode in which only the image forming apparatus of a distribution destination of the job is selected as the execution target in the execution step,

a third selection mode in which all the image forming apparatuses of the distribution source and distribution destination of the job are selected as the execution target in the execution step, and

a fourth selection mode in which an image forming apparatus to process a desired one of a plurality of partial jobs included in the job is selected as the execution target in the execution step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the schematic arrangement of an image processing system according to the first embodiment of the present invention;

FIG. 2 is a block diagram showing the arrangement of an MFP according to the first embodiment of the present invention;

FIG. 3 is a view showing the outer appearance of an operation unit according to the first embodiment of the present invention;

FIG. 4 is a view showing an example of an operation window (initial window) according to the first embodiment of the present invention;

FIGS. 5A to 5C are flowcharts showing processing executed by the MFP according to the first embodiment of the present invention;

FIG. 6 is a view showing an example of a selection window to select an MFP according to the first embodiment of the present invention;

FIG. 7 is a view showing an example of a system condition confirmation window according to the first embodiment of the present invention;

FIG. 8 is a view showing an example of a display job selection window according to the first embodiment of the present invention;

FIG. 9A is a view showing an example of a list display window in job status display according to the first embodiment of the present invention;

FIG. 9B is a view showing an example of the detail window of a list line in FIG. 9A according to the first embodiment of the present invention;

FIG. 9C is a view showing an example of the detail window in FIG. 9B according to the first embodiment of the present invention;

FIG. 10 is a view for explaining the state display of icons according to the first embodiment of the present invention;

FIG. 11 is a view showing an example of a list display window in job log display according to the first embodiment of the present invention;

FIG. 12A is a view showing an example of a list display window in job status display for distributed jobs according to the first embodiment of the present invention;

FIG. 12B is a view showing an example of the detail window of a list line in FIG. 12A according to the first embodiment of the present invention;

FIG. 12C is a view showing an example of the detail window in FIG. 12A according to the first embodiment of the present invention;

FIG. 13 is a view showing an example of a list display window in job status display for single jobs+distributed jobs according to the first embodiment of the present invention;

FIG. 14 is a view showing an example of a priority print selection window according to the first embodiment of the present invention;

FIG. 15 is a view showing an example of a cancel selection window according to the first embodiment of the present invention;

FIG. 16 is a view showing an example of a secure print selection window according to the first embodiment of the present invention;

FIGS. 17A-1 to 17A-3 are views showing an example of the state transition of the operation window according to the first embodiment of the present invention;

FIG. 17B-1 to 17B-3 are views showing an example of the state transition of the operation window according to the first embodiment of the present invention;

FIG. 17C-1 to 17C-4 are views showing an example of the state transition of the operation window according to the first embodiment of the present invention;

FIGS. 18A and 18B are views showing an example of the state transition of the operation window according to the first embodiment of the present invention;

FIGS. 19A to 19D are views showing an example of the state transition of the operation window according to the first embodiment of the present invention;

FIGS. 20A to 20E are views showing an example of the state transition of the operation window according to the first embodiment of the present invention;

FIGS. 21A and 21B are views showing an example of the state transition of the operation window according to the first embodiment of the present invention; and

FIGS. 22A to 22C are views showing an example of the state transition of the operation window according to the first embodiment of the present invention.

### DETAILED DESCRIPTION OF THE PREFERRED EMBODIMENTS

Preferred embodiments of the present invention will now be described in detail in accordance with the accompanying drawings.

### First Embodiment

[Overall Configuration]

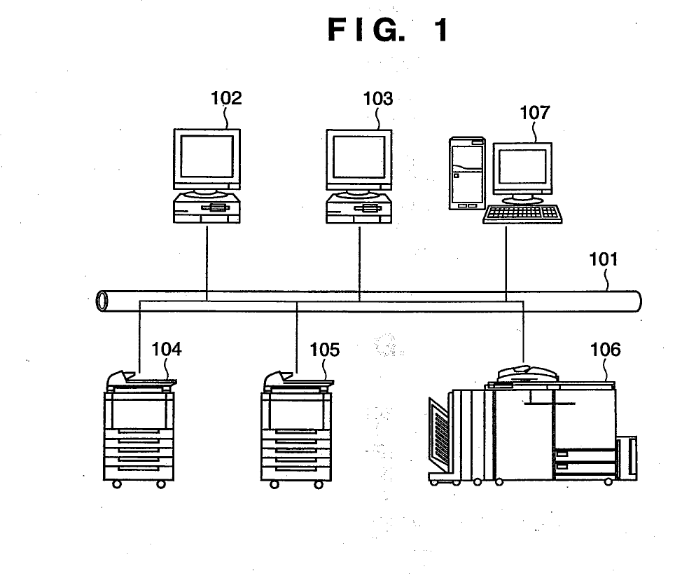

FIG. 1 is a view showing the schematic arrangement of an image processing system according to the first embodiment of the present invention.

Personal computers (PCs) 102, 103, and 107 and MFPs (Multi Function Peripherals) 104, 105, and 106 serving as image forming apparatuses are connected to a network 101. More PCs or MFPs may be connected, although not illustrated in FIG. 1.

The PCs will be represented by the PC 102, and the MFPs will be represented by the MFP 104 hereinafter.

[Arrangement of MFP]

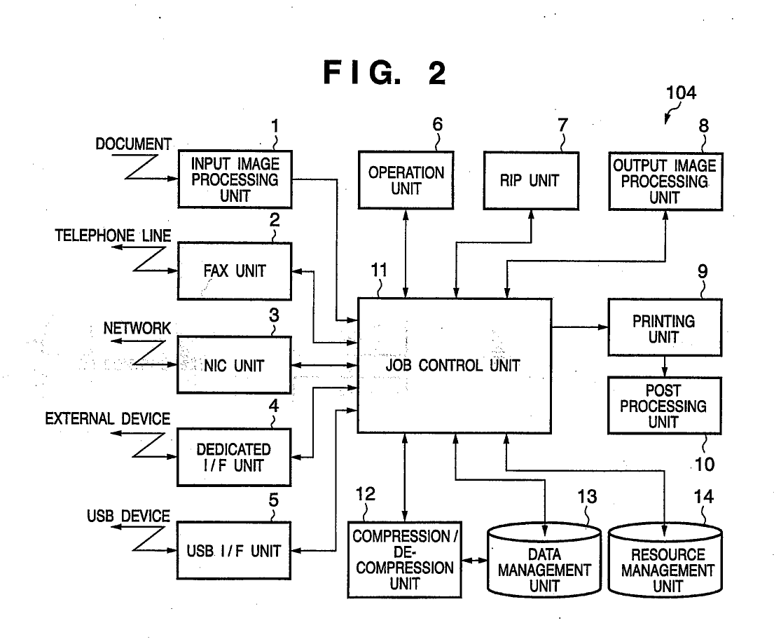

The arrangement of the MFP will be described next with reference to FIG. 2.

FIG. 2 is a block diagram showing the arrangement of the MFP according to the first embodiment of the present invention.

The MFP 104 incorporates a storage device such as a hard disk capable of storing the data of a plurality of jobs (job data). The MFP 104 is an image forming apparatus having a plurality of functions. An example of the functions is a copy function of allowing a printing unit to print, through the storage device, job data output from, e.g., a scanner. Another example is a print function of allowing the printing unit to print, through the storage device, job data output from an external device such as a computer.

The MFP 104 may be a full-color device or monochrome device. Basically, a full-color device often includes the arrangement of a monochrome device, except color processing and internal data. A full-color device will mainly be described here, and a monochrome device will be explained additionally as needed.

The arrangement of the image processing system may comprise both an image forming apparatus of multifunctional type with multiple functions and an SFP (Single Function Peripheral) which serves as an image forming apparatus of single function type with only the print function. Alternatively, the system may comprise an image forming apparatus of only one type. The system may comprise a plurality of image forming apparatuses of both types. The arrangement need only realize control of the first embodiment.

As shown in FIG. 2, the MFP 104 comprises an input image processing unit 1 which reads the image of, e.g., a paper document and processing the read image data, and a FAX unit 2 represented by a facsimile apparatus which transmits/receives an image by using a telephone line. The MFP 104 also comprises a NIC (Network Interface Card) unit 3 which transmits image data or device information by using a network, and a dedicated interface (I/F) unit 4 which exchanges information such as image data with an external device. The MFP 104 also comprises a USB (Universal Serial Bus) interface (USB I/F) unit 5 which transmits/receives data such as image data to/from a USB device represented by a USB memory (a kind of removable medium).

The input image processing unit 1 is implemented by, e.g., a scanner having an ADF (Automatic Document Feeder).

A job control unit 11 controls various kinds of processing of various data in accordance with the application purpose of the MFP 104 by, e.g., temporarily saving image data or determining a data transfer route.

A data management unit 13 is implemented by a storage device such as a hard disk capable of storing a plurality of image data. For example, a control unit (e.g., the CPU and memories (RAM and ROM) of the job control unit 11) provided in the image forming apparatus serves as a main unit to control to store a plurality of types of image data in the data management unit 13. The data include, e.g., image data from the input image processing unit 1 and image data of a facsimile job input through the FAX unit 2. The data also include image data input from an external device through the NIC unit 3 and image data input through the dedicated I/F unit 4 or USB I/F unit 5.

The job control unit 11 executes control to read out image data stored in the data management unit 13 as needed, transfer the image data to an output unit such as a printing unit 9, and execute output processing such as print processing by the printing unit 9. The job control unit 11 also executes control to transfer or distribute image data read out from the data management unit 13 to at least one external device such as a computer or another image forming apparatus in accordance with an instruction from the operator.

In storing image data in the data management unit 13, the image data is compressed as needed through a compression/decompression unit 12 and stored. Conversely, in reading out compressed image data, the data is decompressed to the original data through the compression/decompression unit 12. As is generally known, data is transmitted through the network by using compressed data such as JPEG, JBIG, or ZIP. The data is input to the MFP 104 and decompressed by the compression/decompression unit 12.

A resource management unit 14 stores data of various kinds of parameter tables such as a font, color profile, and gamma table which are commonly handled in various kinds of image processing. These data can be invoked as needed. A new parameter table may be stored, or a table may be corrected and updated. A job management table and job log table to be described later are also managed by the resource management unit 14.

When PDL (Page Description Language) data is input to the job control unit 11, a RIP (Raster Image Processor) unit 7 executes RIP processing, or an output image processing unit 8 processes, for printing, the image to be printed as needed. The intermediate data of the image data or print ready data (bitmap data for printing or compressed data thereof) generated at this time can be stored in the data management unit 13 again as needed.

The image data which has undergone various kinds of processing is transmitted to the printing unit 9 which executes image formation. A printing medium printed by the printing unit 9 is sent to a post processing unit 10 which sorts or finishes the printing medium.

The job control unit 11 plays a role to smoothly flow a job. The job control unit 11 controls switching of the processing path of the constituent elements in the MFP 104 to execute following functions A) to N) in accordance with the operation contents of the MFP 104.

As is known, image data is stored as needed as intermediate data. However, no accesses except those using the data management unit 13 as the start or end point are described. In addition, the processing of the compression/decompression unit 12 and post processing unit 10 to be used as needed and the processing of the job control unit 11 as the core of the entire system will be omitted such that an approximate flow can be understood.
A) Copy function: input image processing unit 1→output image processing unit 8→printing unit 9
B) Facsimile transmission function: input image processing unit 1→FAX unit 2
C) Facsimile reception function: FAX unit 2→output image processing unit 8→printing unit. 9
D) Network scan: input image processing unit 1→NIC unit 3
E) Network print: NIC unit 3→RIP unit 7→output image processing unit 8→printing unit 9
F) Scan to external device: input image processing unit 1→dedicated I/F unit 4
G) Print from external device: dedicated I/F unit 4→RIP unit 7→output image processing unit 8→printing unit 9
H) scan to external memory; input image processing unit 1→USB I/F unit 5
I) Print from external memory: USB I/F unit 5→RIP unit 7→output image processing unit 8→printing unit 9
J) Box scan function: input image processing unit 1→output image processing unit 8→data management unit 13
K) Box print function: data management unit 13→printing unit 9
L) Box reception function: NIC unit 3→RIP unit 7→output image processing unit 8→data management unit 13
M) Box transmission function: data management unit 13→NIC unit 3
N) Preview function: data management unit 13→operation unit 6

Combinations with various functions including an e-mail service and Web server function are also available, though a description thereof will be omitted here.

Of the above-described functions A) to N), J) box scan function, K) box print function, L) box reception function, and M) box transmission function are the processing functions of the MFP 104 including data write and read using the data management unit 13. With these processing functions, data is temporarily saved by dividing the storage area in the data management unit 13 for each Job or user and input/output by combining a user ID and password.

The operation unit 6 is used to select the above-described various flows or functions or instruct operations. When the resolution of the display device of the operation unit 6 increases, processing of displaying a preview of image data stored in the data management unit 13 and printing the image data if the preview is confirmed to be OK can also be implemented.

[Arrangement of Operation Unit]

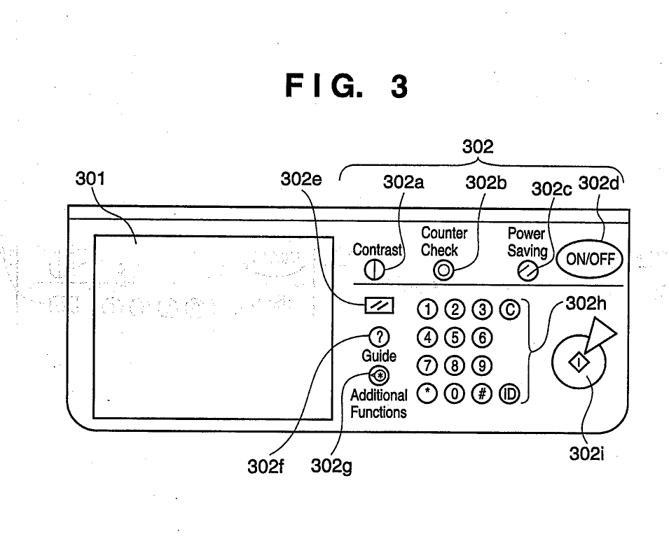

FIG. 3 is a view showing the outer appearance of the operation unit according to the first embodiment of the present invention.

The operation unit 6 includes a touch panel LCD 301 capable of displaying the state of the MFP 104 or inputting an instruction, and a hard key group 302 including a ten-key pad and power button.

The LCD 301 displays a UI (User Interface) corresponding to each function to be implemented by the MFP 104 and changes the window in accordance with input from the touch panel or hard keys.

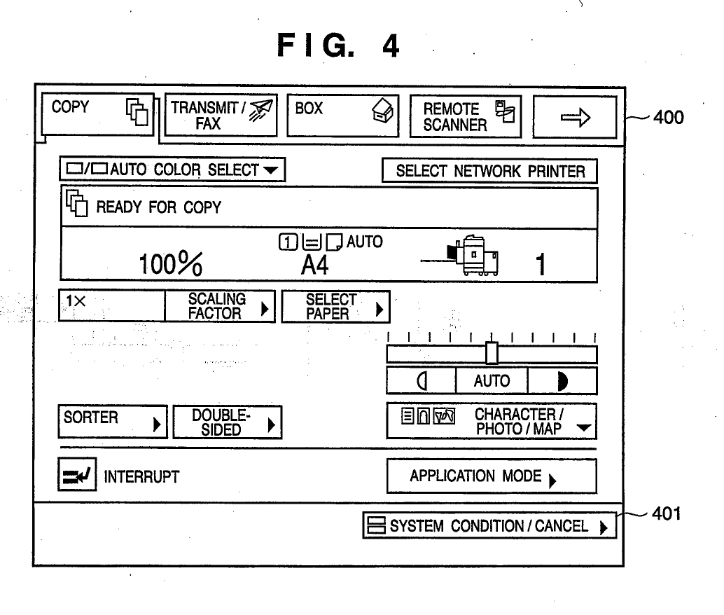

In the LCD 301, operation interfaces corresponding to the operations (e.g., copy function, transmission/facsimile function, box function, and remote scan function) of the MFP 104 are prepared. The user can execute various operations through an operation window (initial window) 400 (FIG. 4) in accordance with the application purpose or object. On the operation window 400, the user can grasp the job processing state or hardware state (e.g., door open or paper) of the MFP 104 by operating a system condition/cancel button 401.

The hard key group 302 has the following buttons.

A contrast volume button (Contrast) 302a to change the contrast of the LCD 301,

a counter button (Counter Check) 302b to display a counter window,

a power save button (Power Saving) 302c to power off only the LCD 301,

a power button 302d to power on/off the MFP 104,

a reset button 302e to cancel an operation,

a guide button (Guide) 302f to display a guidance for the operator,

a user mode button (Additional Function) 302g to change the window to a user mode,

ten-key buttons 302h including a ten-key group to input numbers, and

an execute button 302i to start copy or scanning.

Information input from the hard key group 302 is always updated by communication with the job control unit 11 and the like. The window is changed by using the result.

[Single Job and Distributed Job]

The MFP 104 can process a job issued from the PC 102 or the MFP 105 or 106 in one of two modes. In one mode, a job can be processed by only the MFP 104 (single job (single print mode)). In the other mode, a job can be distributed to the plurality of MFPs 104, 105, and 106 by using the function of the data management unit 13 and processed (distributed job (distributed print mode)).

A single job is wholly printed by one MFP. On the other hand, a distributed job is divided into a plurality of partial jobs in accordance with the number of copies, the number of pages, and color/monochrome pages. The partial jobs are distributed to the MFPs so that each partial job can be printed.

For example, assume that the MFP 104 with a low print speed and the MFP 105 with a high print speed are present on the network 101, and a total of 30 copies of a printed product are to be printed. In this case, the job can be ended in a shorter time by distributing 10 copies to the MFP 104 with the low print speed and 20 copies to the MPP 105 with the high print speed rather than by causing only the MFP 105 with the high print speed to print all copies. As described above, especially when the distributed job is applied to a job that requires mass print processing, the operation time can be shortened.

In the above-described example, a job is distributed on the basis of the number of copies. A distributed job based on the number of pages or color pages/monochrome pages can also be implemented.

For example, assume that a printed product with a total of 30 pages is produced by executing a distributed job based on the number of pages. Printing is executed by distributing pages 1 to 10 to the MFP 104 and pages 11 to 30 to the MFP 105. In this way, the entire job can be ended in a shorter time.

For a distributed job based on color pages/monochrome pages, distributed printing is executed by sorting pages to monochrome pages and color pages in the job. That is, of a total of 100 pages, 70 monochrome pages are printed by the MFP 106 capable of high-speed monochrome printing. Of 30 pages to be color-printed, 10 pages are printed by the MFP 104 capable of color printing. Twenty remaining pages are printed by the MFP 105 capable of color printing. In this way, the entire job can be ended in a shorter time.

As described above, especially when a job that requires mass print processing is to be processed, a combination of MFPs having an engine capable of processing the job is selected on the network. In accordance with the selected combination, one job is divided into a plurality of partial jobs. The partial jobs are distributed to the MFPs and processed. Hence, the job process time can more efficiently be changed (shortened).

To select MFPs as the target of a distributed job, for example, the resource management unit 14 in each MFP manages a device information table which manages device information about the MFPs including the processing capabilities and processing states of the MFPs including itself. MFPs as the target of a distributed job are selected by looking up the device information table.

The processing capability of an MFP includes, e.g., the print speed, color/monochrome, finisher availability, printable size (e.g., A4, A3, B4, or B5), and number of fed papers.

[Processing Flow]

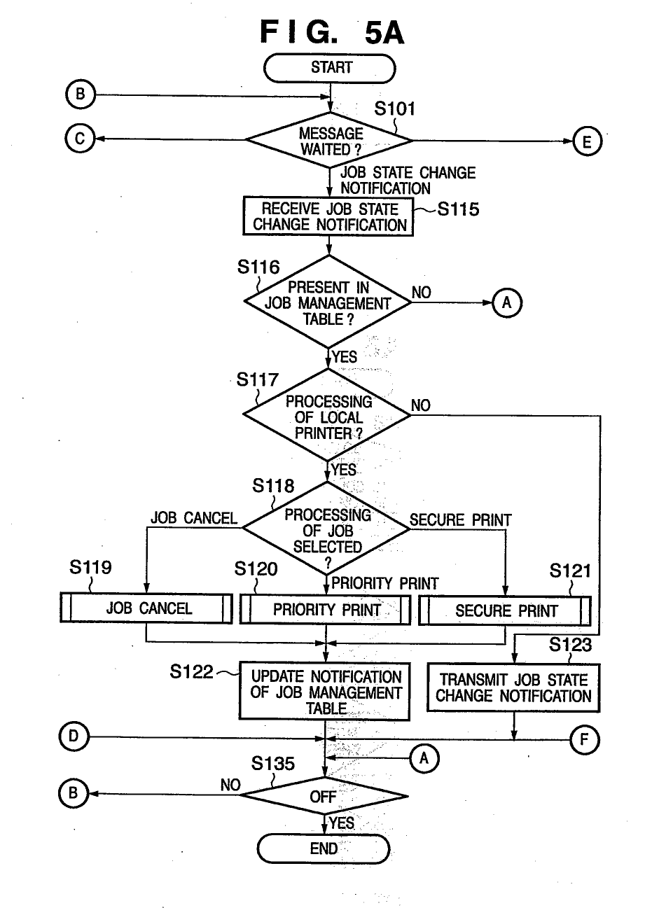

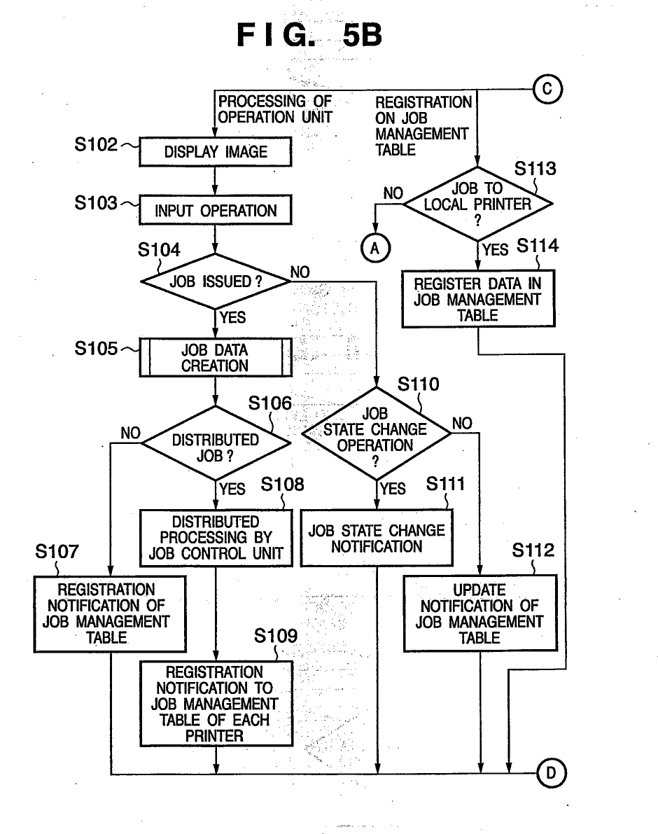

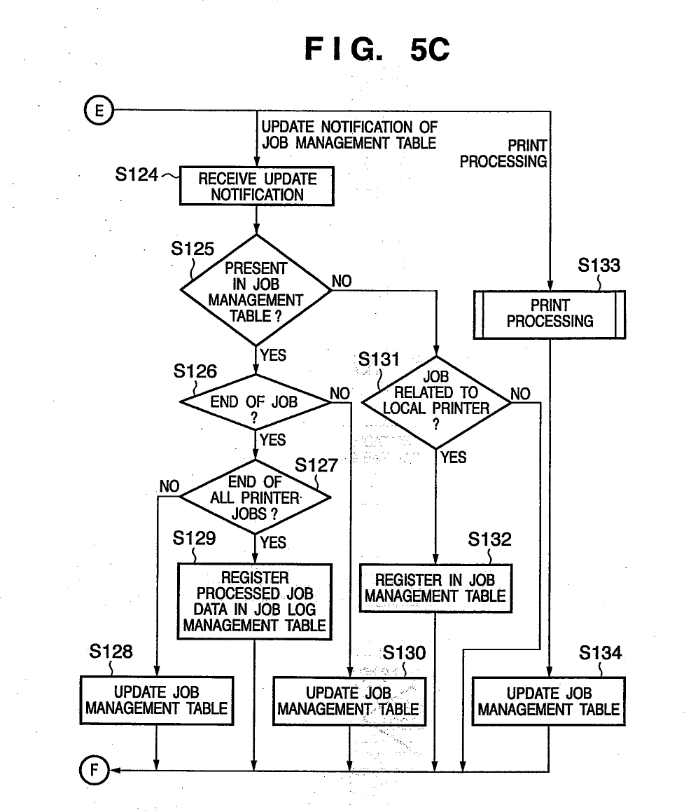

FIGS. 5A to 5C are flowcharts showing processing executed by the MFP according to the first embodiment of the present invention.

FIGS. 5A to 5C show processing of parts related to the present invention, although the MFP serving as an image forming apparatus also has processing except that shown in this flowchart. Details of operations in the processing and operation windows to execute the processing will be described separately.

In the first embodiment, an MFP to be operated (focused) by the operator will be referred to as a “local printer”, and the remaining MFPs connected to the local printer through the network will be referred to as “remote printers” for the descriptive convenience.

The local printer and remote printers can exchange various kinds of data such as their statuses and jobs on the basis of address information such as an IP address set in each printer.

In step S101, the local printer waits for a message. The message is generated by operating the operation unit 6 or issued by the job control unit 11 upon receiving a job from a remote printer. This is a message or command serving as a trigger of predetermined processing by the MFP.

If the message received in step S101 is related to the operation unit 6, the flow advances to step S102 to display the operation window 400 (FIG. 4) to operate the MFP. In step S103, an operation input to the operation window 400 is received.

In step S104, it is determined whether the received operation input is job issue. If it is not job issue (NO in step S104), the flow advances to step S110. If it is job issue (YES in step S104), the flow advances to step S105 to create job data of the job. In the first embodiment, job data of a single job or distributed job is created. The job issue method will be described later in detail.

In step S106, it is determined whether the created job data is a distributed job. If it is no distributed job (NO in step S106), the job is a single job. The flow advances to step S107 to issue a registration notification to register job information about the job data in a job management table. The flow advances to step S135.

The job management table manages job information about job data. In the first embodiment, the job management table manages information representing, e.g., the job contents (e.g., the number of sheets, print size, and number of copies), status (e.g., printing, standby, and cancel), and whether the job is a single job or distributed job. The job management table is managed by, e.g., the resource management unit 14.

If the job data is determined as a distributed job in step S106 (YES in step S106), the flow advances to step S108. The job control unit 11 executes distributed processing. MFPs as distribution destinations are selected, and job data for the distributed job to be assigned to the selected MFPs is created. In step S109, a registration notification to request each MFP as the distribution destination to register the job data for the distributed job in the job management table. Upon receiving the registration notification, each MFP receives the job data for the distributed job assigned to itself from the MFP as the registration notification issue source. Then, the flow advances to step S135.

If it is determined in step S104 that the operation input is not job issue (NO in step S104), it is determined in step S110 whether the operation input is a job state change operation. If it is a state change operation (YES in step S110), the flow advances to step S111 to issue a job state change notification in accordance with the operation contents. Then, the flow advances to step S135.

If it is no state change operation (NO in step S110), the flow advances to step S112 to issue an update notification to update the job management table as needed (e.g., a change in printing state, the start of printing, or the end of printing). Then, the flow advances to step S135.

If the message received in step S101 indicates a registration notification in the job management table, the flow advances to step S113 to determine whether the registration destination of the registration target job information is the local printer. If it is not the local printer (No in step S113), i.e., the registration destination of the registration target job information is a remote printer, the registration notification is transmitted to the remote printer as the registration destination. Then, the flow advances to step S135.

If the registration destination of the registration target job information is the local printer (YES in step S113), the flow advances to step S114 to register the job information in the job management table of the local printer. Then, the flow advances to step S135.

If the message received in step S101 indicates a job state change notification, the flow advances to step S115 to receive the job state change notification. It is determined in step S116 whether the job information to be changed is present in the job management table. If the job information is absent (NO in step S116), the flow advances to step S135. If the job information is present (YES in step S116), the flow advances to step S117.

In step S117, it is determined whether the job information to be changed is information to be processed by the local printer. If it is no information to be processed by the local printer (NO in step S117), i.e., it is information to be processed by a remote printer, the flow advances to step S123 to transmit the job state change notification to the remote printer as the notification destination.

If the job information to be changed is information to be processed by the local printer (YES in step S117), the flow advances to step S118 to determine the change contents of the job state change notification.

If the change contents determined in step S118 indicate job cancel, the flow advances to step S119 to execute job cancel processing of the job as the processing target. A detailed example of the job cancel processing will be described later. The flow advances to step S122 to issue an update notification to update the contents of the job management table in accordance with the job cancel. Then, the flow advances to step S135.

If the change contents determined in step S118 indicate priority print, the flow advances to step S120 to execute priority print processing of the job as the processing target. A detailed example of the priority print processing will be described later. The flow advances to step S122 to issue an update notification to update the contents of the job management table in accordance with the priority print. Then, the flow advances to step S135.

If the change contents determined in step S118 indicate secure print, the flow advances to step S121 to execute secure print processing of the job as the processing target. A detailed example of the secure print processing will be described later. The flow advances to step S122 to issue an update notification to update the contents of the job management table in accordance with the secure print. Then, the flow advances to step S135.

If the message received in step S101 indicates a job management table update notification, the flow advances to step S124 to receive the update notification. It is determined in step S125 whether the job information to be updated is present in the job management table. If the job information is absent (NO in step S125), the flow advances to step S131. If the job information is present (YES in step S125), the flow advances to step S126.

In step S126, it is determined whether the update contents of the job information to be updated indicate a job end. If it is no job end (NO in step S126), the flow advances to step S130 to update the management contents of the job management table on the basis of the update contents (e.g., priority print setting or secure print setting). Then, the flow advances to step S135.

If it is a job end (YES in step S126), and especially, when the job is a distributed job, the flow advances to step S127 to determine whether the job is ended in all printers of the distribution destination. If the job is not ended in all printers of the distribution destination (NO in step S127), the flow advances to step S128 to update the management contents of the job management table on the basis of the ended job. Then, the flow advances to step S135.

If the job is ended in all printers of the distribution destination (YES in step S126), the flow advances to step S129 to register the processed job data in the job log management table.

The job log management table manages job information about processed job data. In the first embodiment, the job log management table manages information representing, e.g., the job contents (e.g., the number of sheets, print size, and number of copies), status (e.g., print OK/print NG), and whether the job is a single job or distributed job. The job log management table is managed by, e.g., the resource management unit 14.

If the job information to be updated is absent in the job management table in step S125 (NO in step S125), the flow advances to step S131. It is determined whether the update contents of the update notification indicate a job related to the local printer (e.g., a job as a processing target of priority print setting or secure print setting).

If the update contents of the update notification indicate no job related to the local printer (NO in step S131), the flow advances to step S135. If the update contents of the update notification indicate a job related to the local printer (YES in step S131), the flow advances to step S132 to update the management contents of the job management table on the basis of the update contents. Then, the flow advances to step S135.

If the message received in step S101 indicates print processing, the flow advances to step S133 to execute print processing of the job as the processing target. The print processing is the same as described above. In step S134, the management contents of the job management table are updated in accordance with the print processing state. Then, the flow advances to step S135.

In step S135, it is determined whether the power OFF operation is executed. If no power OFF operation is executed (NO in step S135), the flow returns to step S101 in accordance with the operation contents/processing contents to wait for a message and execute processing in accordance with the received message until the power OFF operation is executed. If the power OFF operation is executed (YES in step S135), the processing is ended.

[Single Job Issuing Method]

The single job issuing method of the copy function will be described below.

In a single job, the operator sets a document to be copied on the ADF of the input image processing unit 1 and operates the execute button 302i (FIG. 3). The copy of the document can be printed by the MFP (local printer) operated by the operator.

The document set on the ADF is input from the input image processing unit 1 as digital data and saved in the data management unit 13 via the output image processing unit 8. If setting input from the operation unit 6 indicates a single job, the job control unit 11 determines it and transmits print data to the printing unit 9 of the local printer.

[Distributed Job Issuing Method]

The distributed job issuing method of the copy function will be described below.

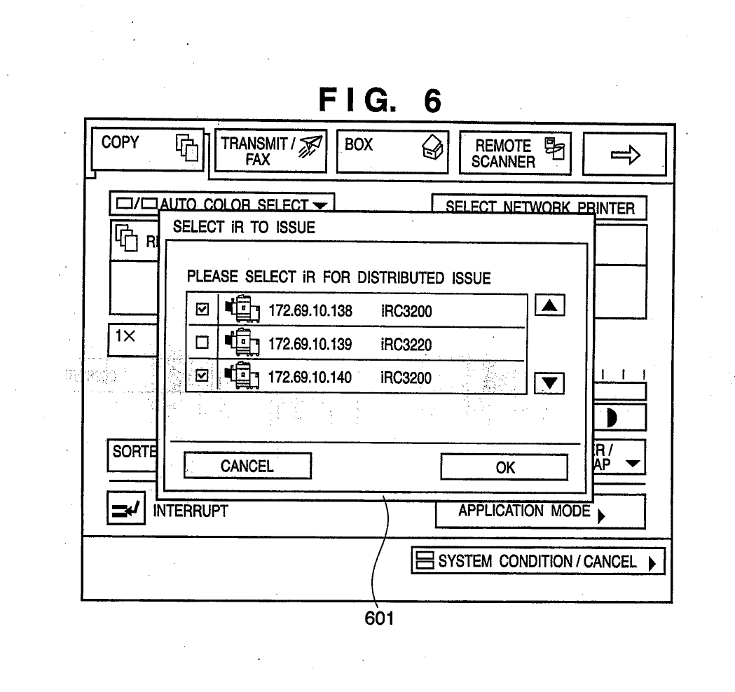

When MFPs capable of executing a distributed job exist on the network 101, the operator can select, through a selection window 601 (FIG. 6), the MFPs capable of distributed issue from the operation window displayed on the LCD 301 of the operation unit 6.

The operator can instruct to distribute a job to selected MFPs and print it by setting a document to be copied on the ADF of the input image processing unit 1 and operating the execute button 302i (FIG. 3). For a printed product having a total of, e.g., 100 pages, 50 pages can be distributed to each of the MFPs 104 and 105.

The printed product set on the ADF is input from the input image processing unit 1 as digital data and saved in the data management unit 13 via the output image processing unit 8. If setting input from the operation unit 6 indicates a distributed job, the job control unit 11 determines it and transmits print data corresponding to the distribution setting condition to each image forming apparatus (MFP in the first embodiment) to be used for the distributed job. In the above example, print data of 50 pages is transmitted to the MFP 105, and print data of the 50 remaining pages is transmitted to the MFP 104.

[Status Display of Single Job and Distributed Job]

The processing state (e.g., print state) of a single job or distributed job for at least one MFP including the MFP operated by the operator can be confirmed on the operation unit 6.

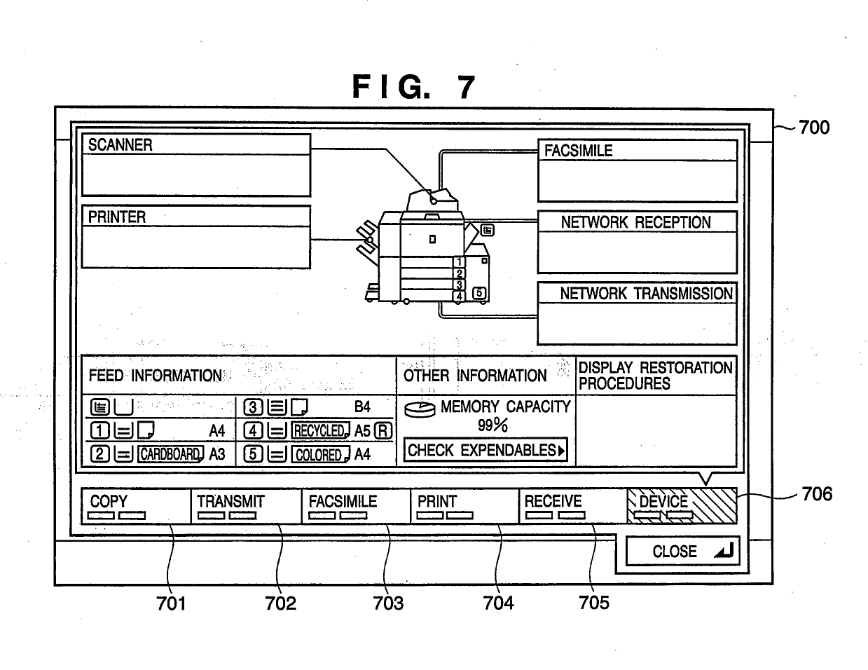

To confirm the print state of each MFP in the print function, the system condition/cancel button 401 is operated on the operation window 400 (FIG. 4). Then, the window changes to a system condition confirmation window 700 (FIG. 7). The system condition confirmation window 700 includes tabs 701 to 706 (copy, transmit, fax, print, receive, and device) to select statuses of various kinds of processing functions. When the operator selects a desired tab, he/she can confirm the status for the selected tab.

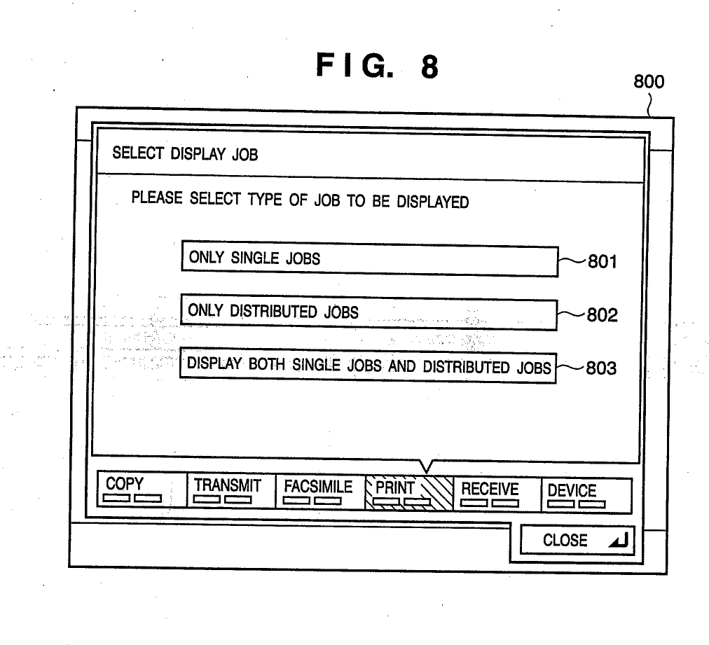

When the print tab 704 is selected, a display job selection window 800 (FIG. 8) to select a job to be confirmed (displayed) is displayed. The display job selection window 800 includes buttons 801 to 803 to select the statuses of only single jobs, only distributed jobs, or both single and distributed jobs (single jobs+distributed jobs). When the operator operates a desired button, he/she can confirm the statuses of jobs corresponding to the selected button.

Examples of windows displayed when the buttons 801 to 803 are operated will be described below.

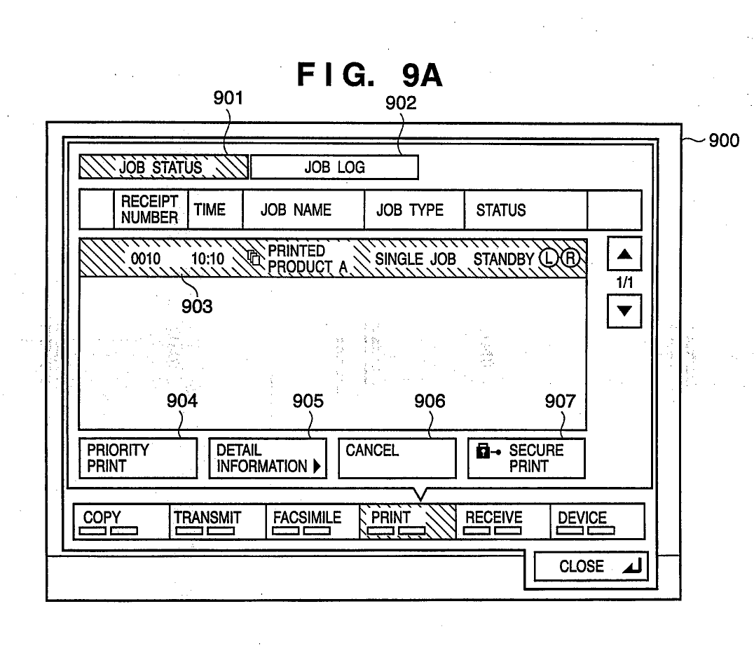

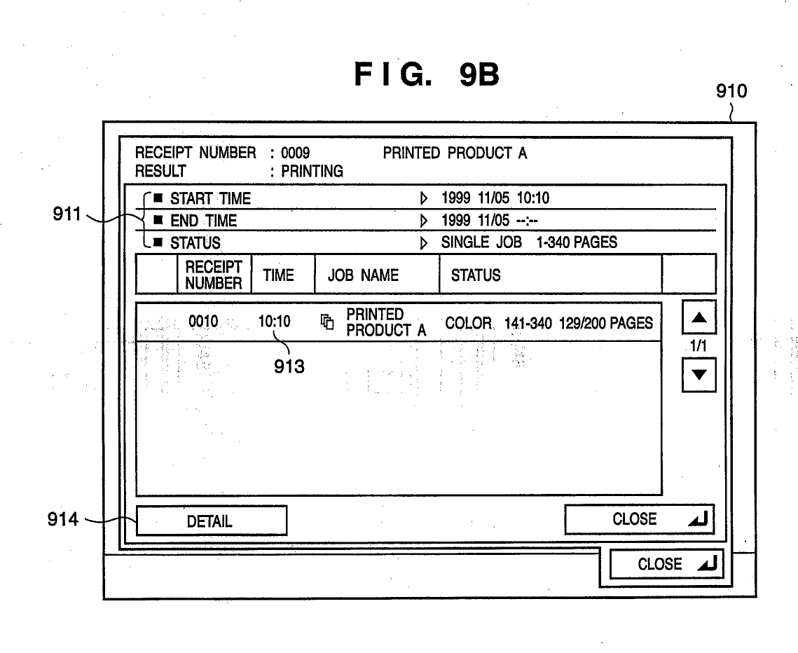

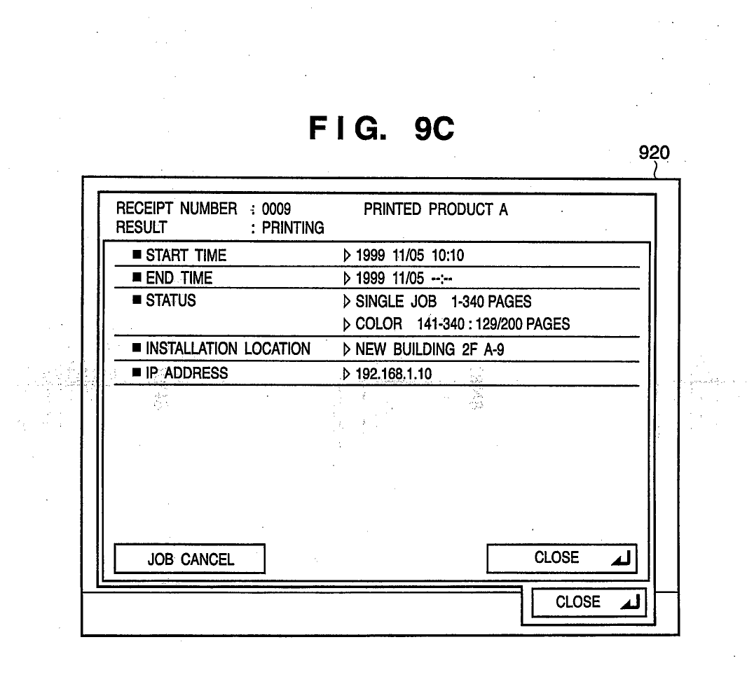

When the button 801 (“only single jobs”) is operated, a list display window 900 (FIG. 9A) as a list containing the statuses of only single jobs to be processed by the local printer is displayed. Pieces of job information of at least one MFP are saved on the job management table to manage jobs in the MFP. Whether each job is a single job or distributed job can be confirmed. When the job management table is looked up, the list display window 900 of single jobs can be generated and displayed.

When a job status display button 901 of job log display button 902 is operated on the list display window 900, two kinds of status display (job status display and job log display) can be done. When one of the buttons 801 to 803 of the display job selection window 800 is operated, job status display corresponding to the operated button is done by default.

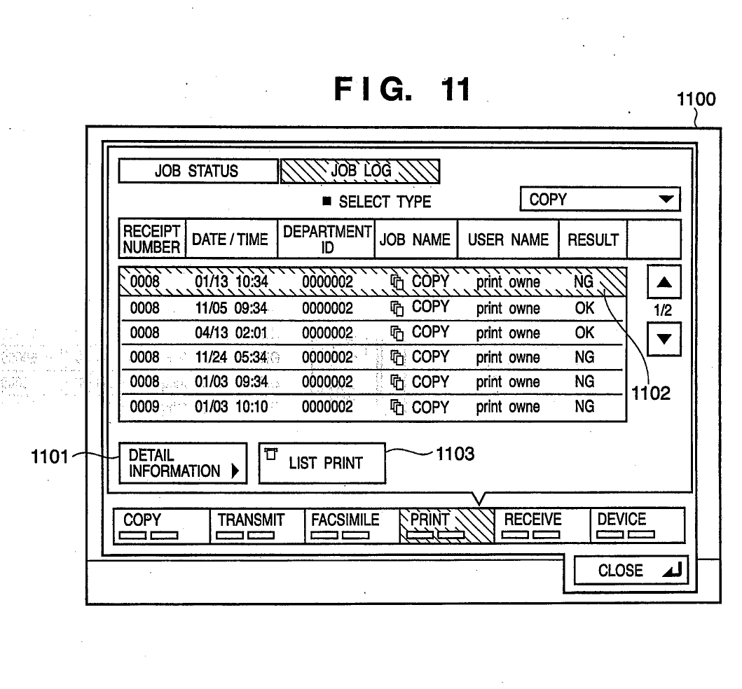

When the job log display button 902 is operated in the state shown in FIG. 9A, a list display window 1000 (FIG. 11) is displayed in which a list containing the processing statuses (log) of only jobs processed by the local printer in the past is displayed.

As described above, in the first embodiment, two kinds of status display (job status display and job log display) exist as job status display.

The status display will be explained below in more detail.

In the first job status display (FIG. 9A), the status of a job which is being processed currently can be confirmed. The job status always changes. For this reason, the job management table always updates the job status transmitted from at least one MFP and always saves the latest status.

A list line 903 in FIG. 9A has display items including a unique receipt number issued upon receiving a job, time, job name, job type (single job/distributed job), and status (printing/error/standby/print end).

The “status” item in the list line indicates the processing state of each of the local printer and remote printers. Two kinds of icons “◯” are displayed depending on the processing source (position) of the target job. Especially, when the job processing source is the local printer (local job), “L” is displayed in the icon “◯”. When the job processing source is a remote printer (remote job), “R” is displayed in the icon “◯”. Hence, the operator can easily confirm the job processing source.

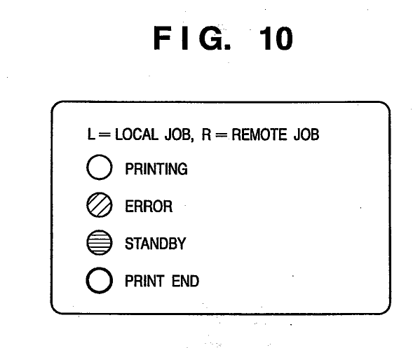

Each icon “◯” is distinguished by color on the basis of the contents of the processing state. For example, as shown in FIG. 10, when the processing state is “printing”, the icon “◯” is indicated by “green”. For “error”, the icon “◯” is indicated by “red”. For “standby”, the icon “◯” is indicated by “gray”. When the processing state is “print end”, the icon “◯” is indicated by a black outline.

In FIG. 10, the above-described colors are distinguished by different patterns for the illustrative convenience. The indicator form representing the processing state is not limited to the icon. Any other indicator form can be used if the contents of the processing state is identifiable. For example, an indicator that blinks or changes the type of texture/pattern or icon shape may be employed.

As described above, the list display window 900 in FIG. 9A makes a list of job statuses of single jobs on the basis of job information in the job management table. When a desired one of list lines displayed in the list is selected, and a detail information button 905 is operated on the list display window 900, the detailed status of the job corresponding to the list line can be confirmed (FIGS. 9B and 9C).

FIG. 9B shows a detail window 910 which is displayed when the list line 903 listed on the list display window 900 is selected, and the detail information button 905 is operated. The detail window 910 shows details of the job in the list line 903. On the detail window 910, the job start time, end time, status, job type, and number of print pages are displayed in a region 911. When a list line 913 is selected, and a detail button 914 is operated, a detail window 920 shown in FIG. 9C is displayed. The detail window 920 shows more detail information of the job. In addition to the contents displayed in the region 911 in FIG. 9B, the installation location of the MFP which is executing processing and the IP address set for the MFP are displayed.

In the second job log display (FIG. 11), jobs that ended print processing in certain forms are displayed together. The operator can confirm the final states of jobs processed in the past and their processing results (OK/NG).

A list line 1102 in a list display window 1100 shown in FIG. 11 has display items including a unique receipt number issued upon receiving a job, job end date/time, job name, user name, and result (OK/NG).

Both job status display and job log display can cope with unexpected power-off such as a hit. Even when the power is restored, information in the job management table is saved. When job processing has been ended at the time of power OFF, and a predetermined time has elapsed, job information managed by the job management table is confirmed from the MFP of the local printer.

Even in the job log display, a desired one of list lines displayed in the list on the list display window 1100 is selected, like the status display (FIG. 9A). When a detail information button 1101 is operated, the detailed status of the job corresponding to the list line can be confirmed.

A list print button 1103 is provided as a button to print the contents of the list display window 1100 as needed.

A case will be described next in which the button 802 (“only distributed jobs”) is operated on the display job selection window 800 (FIG. 8).

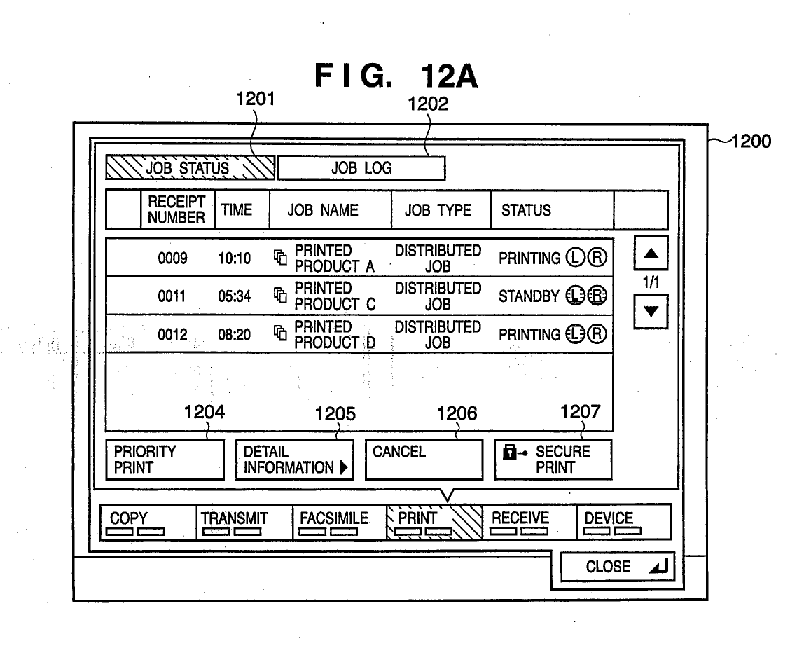

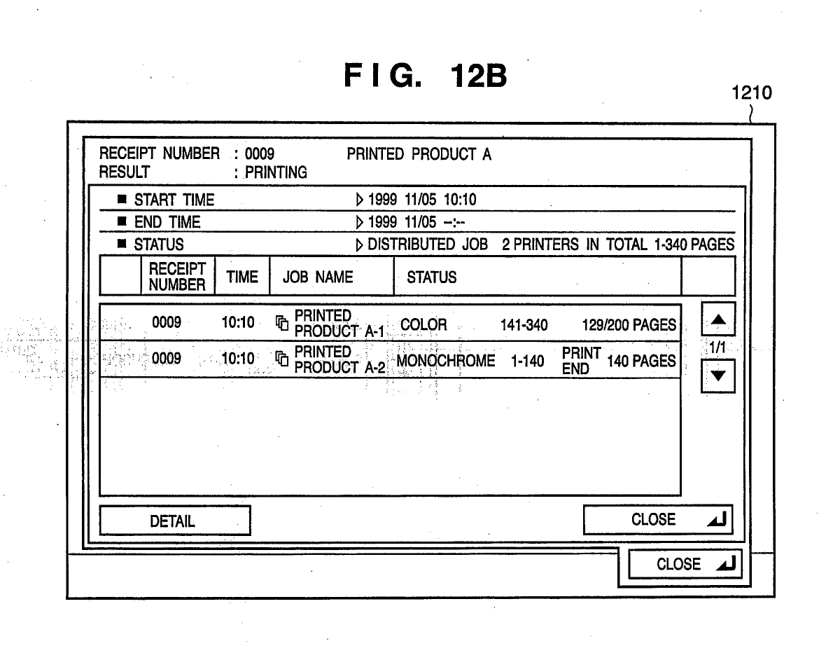

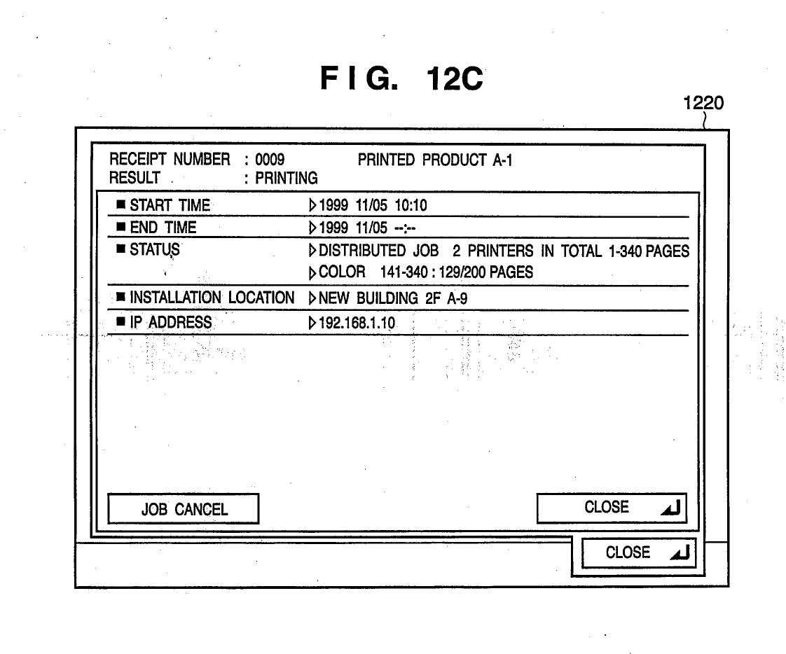

When the button 802 (“only distributed jobs”) is operated, a list display window 1200 (FIG. 12A) as a list containing the statuses of only distributed jobs to be processed by the local printer and remote printers is displayed. The list display window 1200 of distributed jobs can also be generated by looking up the job management table, like the list display window 900 of single jobs.

The list display window 1200 includes a job status display button 1201, job log display button 1202 and detail information button 1205 corresponding to the job status display button 901, job log display button 902, and detail information button 905 on the list display window 900 (FIG. 9A). Like the list display window 900 of single jobs, two kinds of status display and detailed display (FIGS. 12B and 12C) of each list line can be done for each distributed Job on the list display window 1200.

In a distributed job, a plurality of jobs are listed in a detail window 1210 shown in FIG. 12B. Hence, detailed display for a list line selected on the detail window 1210 is done in a detail window 1220 shown in FIG. 12C.

A case will be described next in which the button 803 (“single jobs+distributed jobs”) is operated on the display job selection window 800 (FIG. 8).

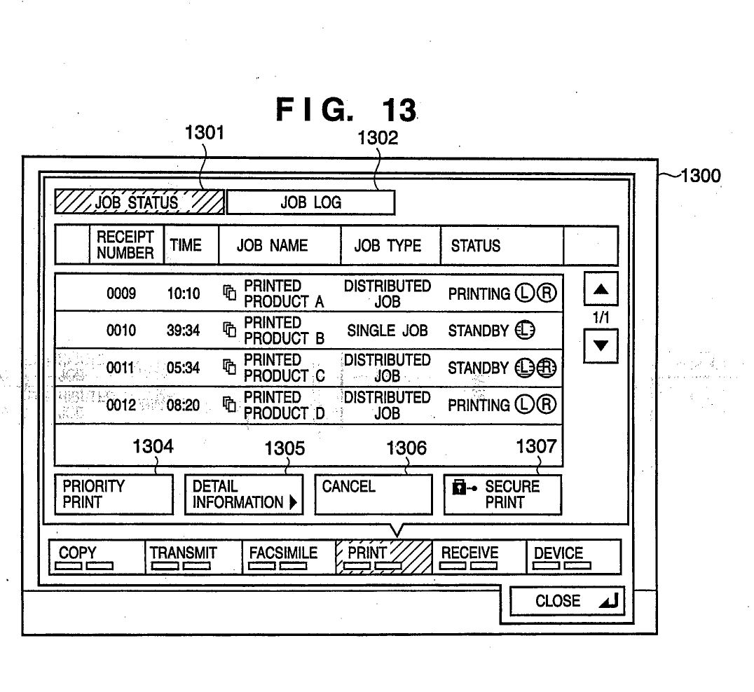

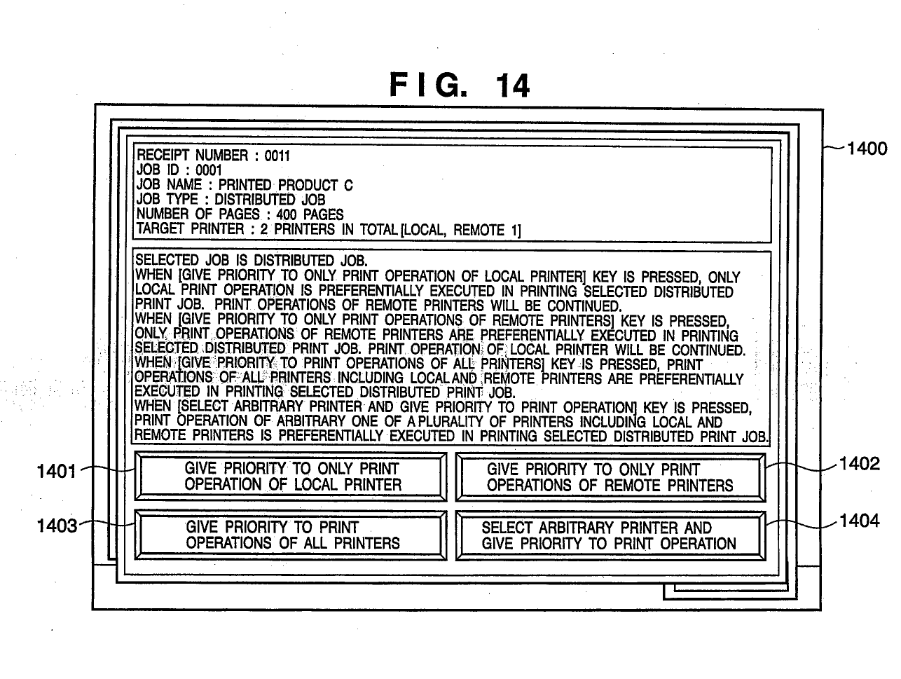

When the button 803 (“single jobs+distributed jobs”) is operated, a list display window 1300 (FIG. 13) as a list containing the statuses of all single jobs and distributed jobs to be processed by the local printer and remote printers is displayed. The list display window 1300 of single jobs+distributed jobs can also be generated by looking up the job management table, like the list display window 900 of single jobs. In this case, however, the display contents and display form are controlled such that single jobs and distributed jobs are distinguishably displayed.

The list display window 1300 includes a job status display button 1301, job log display button 1302 and detail information button 1305 corresponding to the job status display button 901, job log display button 902, and detail information button 905 on the list display window 900 (FIG. 9A). Like the list display window 900 of single jobs and the list display window 1200 (FIG. 12A) of distributed jobs, two kinds of status display and detailed display of each list line can be done for each of the single jobs and distributed jobs on the list display window 1300.

The list display window 1300 can be regarded as a combination of the list display window 900 (FIG. 9A) and list display window 1200 (FIG. 12A). For this reason, when a list line selected in the list display window 1300 indicates a single job, the detail display shown in FIGS. 9B and 9C can be done for the list line. When a selected list line indicates a distributed job, the detail display shown in FIGS. 12B and 12C can be done.

[Job Control]

In the first embodiment, job control of each of a single job and distributed job can be executed by using the operation unit 6.

Job control of a single job will be described first.

[Job Control of Single Job]

For example, when the button 801 (“only single jobs”) is operated on the display job selection window 800, a desired job is selected from the list of single jobs in the displayed list display window 900 (FIG. 9A). Job control of the processing contents or the like can be executed.

Especially, in the list display window 900, a priority print function (priority print button 904), job cancel function (cancel button 906), and secure print function (secure print button 907) can be executed as job control.

The priority print function changes the print order of a job selected from a plurality of jobs issued to the data management unit 13 such that the job is printed next to the job that is currently being printed. Normally, jobs are printed in the order of issue. However, to print a job with a high priority, the order can be changed by using the priority print function.

When the priority print button 904 is operated, the priority of the print operation of the local printer for the single job corresponding to the selected list line is raised. After raising the priority, the local printer is notified of the result which is reflected on the job icon indicator of the job status display.

The operation window of the priority print function will be described later for an example of a distributed job.

The job cancel function cancels printing of a single job corresponding to a selected list line. When the cancel button 906 is operated, all job data processes executed by the printing unit 9 or RIP unit 7 of the local printer are canceled.

For a single job, when the cancel button 906 is operated, the print operation of the local printer is canceled in the single print job to be canceled. The list line of the corresponding job is deleted from the list lines in the job status display. After canceling the print processing, the local printer is notified of the cancel result which is reflected on the job icon indicator of the job status display.

The operation window of the job cancel function will be described later for an example of a distributed job.

The secure print function (authenticated print function) is used to print, e.g., a job such as a confidential document with high confidentiality. For a single job to which secure print is to be applied, a password is set through a UI provided by, e.g., the printer driver of an external device. When the job with the password is issued to the MFP, the data management unit 13 saves the job in a standby state. The output operation of this job does not start until the operator inputs an instruction. Similarly, a job with a password can also be issued on the MFP.

The operator who wants to print the job with the password (also called a secure print job) comes to the MFP to be used for output. In, e.g., the list display window 900 shown in FIG. 9A, the operator selects the list line of the secure print job and selects the secure print button 907. An input window to input the password is displayed upon this selection. The password is input to the input window. Only when the password is correct, the secure print job can be printed.

After starting the secure print, the local printer is notified of the job start result which is reflected on the job icon indicator of the job status display.

If a wrong value is input as the password, no print start instruction is issued. A secure print job which is unnecessary or is unprinted for a long time wastes the memory resource of the MFP. Hence, the operator can delete the secure print job from the list on the list display window 900 as needed.

A time limit may be set for the secure print job. In this case, when the management time of the secure print job managed by the data management unit 13 reaches a predetermined time, the job control unit 11 can automatically delete the secure print job.

The operation window of the secure print function will be described later for an example of a distributed job.

Job control of a distributed job will be described next.

[Job Control of Distributed Job]

For example, when the button 802 (“only distributed jobs”) is operated on the display job selection window 800, a desired job is selected from the list of distributed jobs in the displayed list display window 1200 (FIG. 12A). One of the priority print function, job cancel function, and secure print function can be executed.

A priority print button 1204, cancel button 1206, and secure print button 1207 in the list display window 1200 correspond to the priority print button 904, cancel button 906, and secure print button 907 in the list display window 900 shown in FIG. 9A. The basic operation of each button is the same as that for a single job, and a detailed description thereof will be omitted. Parts unique to the distributed job will mainly be explained below.

As described above, the priority print function changes the print order of a job selected from a plurality of jobs issued to the data management unit 13 such that the job is printed next to the job that is currently being printed.

For example, when the list line of the job as the priority print target is selected on the list display window 1200 (FIG. 12A), and the priority print button 1204 is operated, a priority print selection window 1400 (FIG. 14) is displayed.

The priority print selection window 1400 includes buttons 1401 to 1404 (“give priority to only print operation of local printer”/“give priority to only print operations of remote printers”/“give priority to print operations of all printers”/“select arbitrary printer and give priority to print operation”) to execute four kinds of priority print.

When the button 1401 (“give priority to only print operation of local printer”) is operated, the priority of the print operation of the local printer is raised in the selected distributed job. In this case, no priority is given to the print operation of the remote printers.

When the button 1402 (“give priority to only print operations of remote printers”) is operated, the priority of the print operations of all remote printers is raised in the selected distributed job. In this case, no priority is given to the print operation of the local printer.

When the button 1403 (“give priority to print operations of all printers”) is operated, the priority of the print operations of all of the local printer and remote printers is raised in the selected distributed job.

When the button 1404 (“select arbitrary printer and give priority to print operation”) is operated, a list of related jobs of all of the local printer and remote printers used in the selected distributed job is displayed. In the list, each job can be selected, and its priority can be raised. After the priority of the designated printer is raised, all printers to process the job are notified of the result which is reflected on the job icon indicator of the Job status display in each printer.

The priority print selection window of a single job is basically similar to the priority print selection window 1400. In this case, the operation related to the remote printers is not executed.

The job cancel function cancels printing of a selected job, as described above.

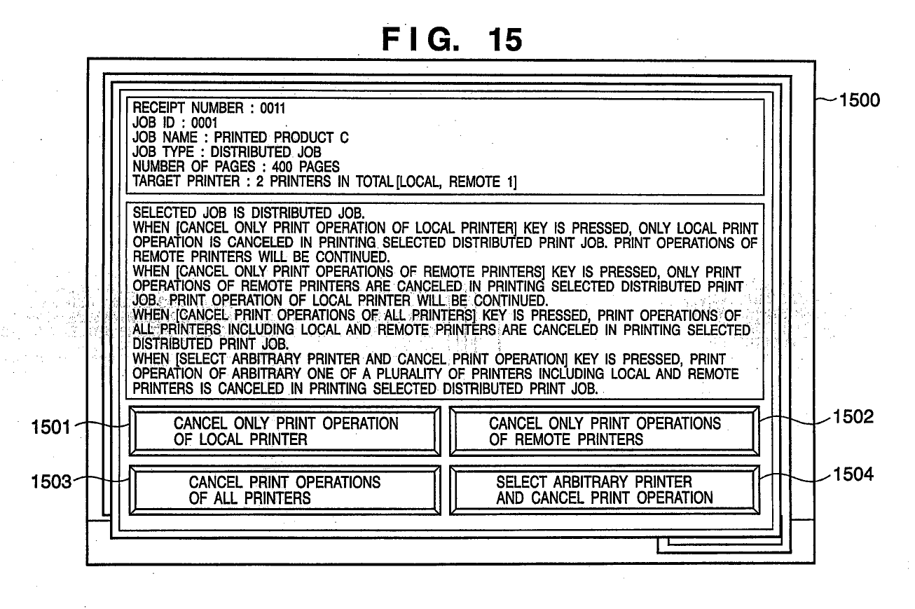

For example, when the list line of the job as the cancel target is selected on the list display window 1200 (FIG. 12A), and the cancel button 1206 is operated, a cancel selection window 1500 (FIG. 15) is displayed.

The cancel selection window 1500 includes buttons 1501 to 1504 (“cancel only print operation of local printer”/“cancel only print operations of remote printers”/“cancel print operations of all printers”/“select arbitrary printer and cancel print operation”) to execute four kinds of cancel.

When the button 1501 (“cancel only print operation of local printer”) is operated, the print operation of the local printer is canceled in the selected distributed job. In this case, the print operations of the remote printers are not canceled.

When the button 1502 (“cancel only print operations of remote printers”) is operated, the print operations of all remote printers is canceled in the selected distributed job. In this case, the print operation of the local printer is not canceled.

When the button 1503 (“cancel print operations of all printers”) is operated, the print operations of all of the local printer and remote printers are canceled in the selected distributed job.

The button 1504 (“select arbitrary printer and cancel print operation”) is operated. In this case, a list of related jobs of all of the local printer and remote printers used in the selected distributed Job is displayed. Each job can be selected and canceled. When the print operation of a job is canceled, the state is reflected on the job icon indicator of the job status display in a corresponding printer.

For example, when only the local printer is selected as an arbitrary printer, the icon in the list line of the job of the local printer is erased.

When only the remote printers are selected as arbitrary printers, the jobs of all remote printers are canceled, and the icon in the list line of the job of each remote printer is erased. However, when at least one printing is being executed by a remote printer, the icon indicator in the list line of the job of the remote printer remains green (printing).

When job cancel is done in a designated printer, all printers to process related jobs are notified of the result which is reflected on the job icon indicator of the job status display in each printer.

The cancel selection window of a single job is basically similar to the cancel selection window 1500. In this case, the operation related to the remote printers is not executed.

The secure print function is used to print a job such as a confidential document with high confidentiality, as described above.

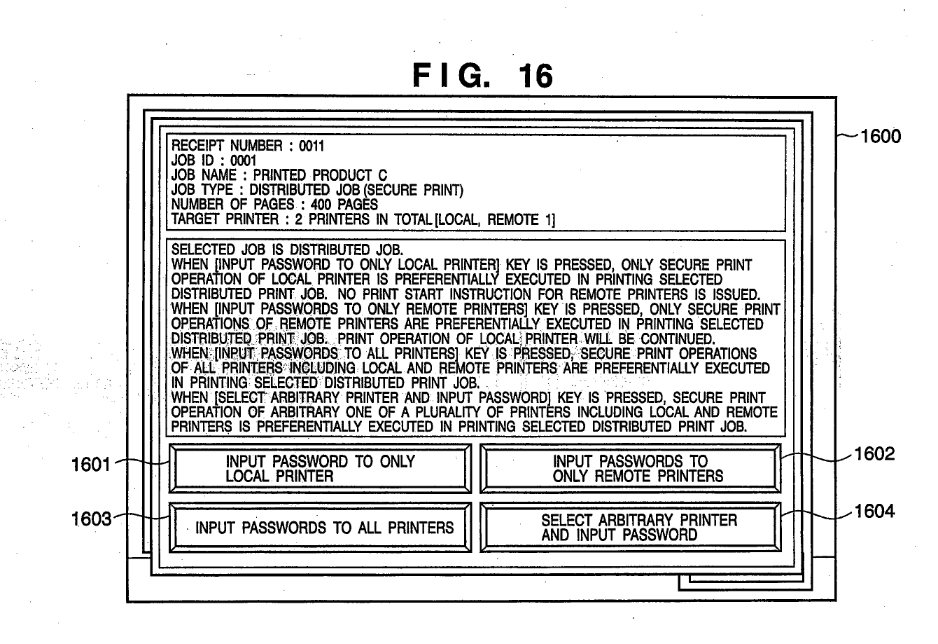

For example, when the list line of the job as the secure print target is selected on the list display window 1200 (FIG. 12A), and the secure print button 1207 is operated, a secure print selection window 1600 (FIG. 16) is displayed.

The secure print selection window 1600 includes buttons 1601 to 1604 (“input password to only local printer”/“input passwords to only remote printers”/“input passwords to all printers”/“select arbitrary printer and input password”) to execute four kinds of secure print.

The button 1601 (“input password to only local printer”) is operated. A password input window to input the password of the local printer in the selected distributed job is displayed. In this case, the print operation of the distributed job by the local printer is not executed until the password is input. Similarly, the print operations by remote printers related to the distributed job are not executed either until the passwords are input.

When the button 1602 (“input passwords to only remote printers”) is operated, a password input window to input the passwords of all remote printers in the selected distributed job at once is displayed. In this case, the print operation of a distributed job on the local printer, which is not related to the selected distributed job, is continued.

When the button 1603 (“input passwords to all printers”) is operated, a password input window to input the passwords of all of the local printer and remote printers in the selected distributed job at once is displayed. In this case, all distributed jobs on the local printer and remote printers become secure print jobs. The print operations are not executed for any distributed job until the passwords are input.

The button 1604 (“select arbitrary printer and input password”) is operated. A list of related jobs of all of the local printer and remote printers used in the selected distributed job is displayed. Each job can be selected, and a password can be input.

After secure print is executed, all printers to process related jobs are notified of the result which is reflected on the job icon indicator of the job status display in each printer.

The secure print selection window of a single job is basically similar to the secure print selection window 1600. In this case, the operation related to the remote printers is not executed.

[Job Control of Single Job+Distributed Job]

For example, the button 803 (“display both single jobs and distributed jobs”) is operated on the display job selection window 800. A desired single job or distributed job is selected from single jobs and distributed jobs in the displayed list display window 1300 (FIG. 13). One of the priority print function, job cancel function, and secure print function can be executed.

The priority print button 1304, cancel button 1306, and secure print button 1307 in the list display window 1300 correspond to the priority print button 904, cancel button 906, and secure print button 907 in the list display window 900 shown in FIG. 9A. The basic operation of each button is the same as that for a single job.

As the priority print function, job cancel function, and secure print function for a single job+distributed job, the above-described manipulations and operations of the functions for a single job or the manipulations and operations of the functions for a distributed job are executed in accordance with the type of the selected job (single job or distributed job).

The operation windows of the priority print function, job cancel function, and secure print function for a single job+distributed job are the same as the above-described windows for only a single job or distributed job in accordance with the type of the selected job.

A change example of the operation window that is switched by various kinds of operations according to the first embodiment will be described below. State G1 to G23 to be explained in the following drawings indicate a change example of the operation window by various kinds of operations in a job status display state.

The states G1 to G3 in FIGS. 17A-1 to 17A-3 are as follows.

G1: The system condition/cancel button 401 is operated on the operation window 400 (FIG. 4).

G2: The system condition confirmation window 700 (FIG. 7) is displayed by operating the system condition/cancel button 401, and the print button 704 is operated.

G3: The display job selection window 800 (FIG. 8) is displayed by operating the print button 704.

One of the states G4 to G6 in FIGS. 17B-1 to 17B-3 is generated in accordance with the operation on the display job selection window 800.

G4: The list display window 900 (FIG. 9A) is displayed by operating the button 801 (“only single jobs”) on the display job selection window 800.

G5: The list display window 1200 (FIG. 12A) is displayed by operating the button 802 (“only distributed jobs”) on the display job selection window 800.

G6: The list display window 1300 (FIG. 13) is displayed by operating the button 803 (“single jobs+distributed jobs”) on the display job selection window 800.

In all the states G4 to G6, a desired job can be selected from the displayed list, and an operation (priority print setting, detail information display, cancel setting, or secure print setting) can be done for the selected job.

The states G7 to G10 in FIGS. 17C-1 to 17C-4 indicate that the list lines of jobs of printed products A to D are selected (focused) in the list displayed in the list display window 1300.

G7: The list line of the job of the printed product A is selected on the list display window 1300.

G8: The list line of the job of the printed product B is selected on the list display window 1300.

G9: The list line of the job of the printed product C is selected on the list display window 1300.

G10: The list line of the job of the printed product D is selected on the list display window 1300.

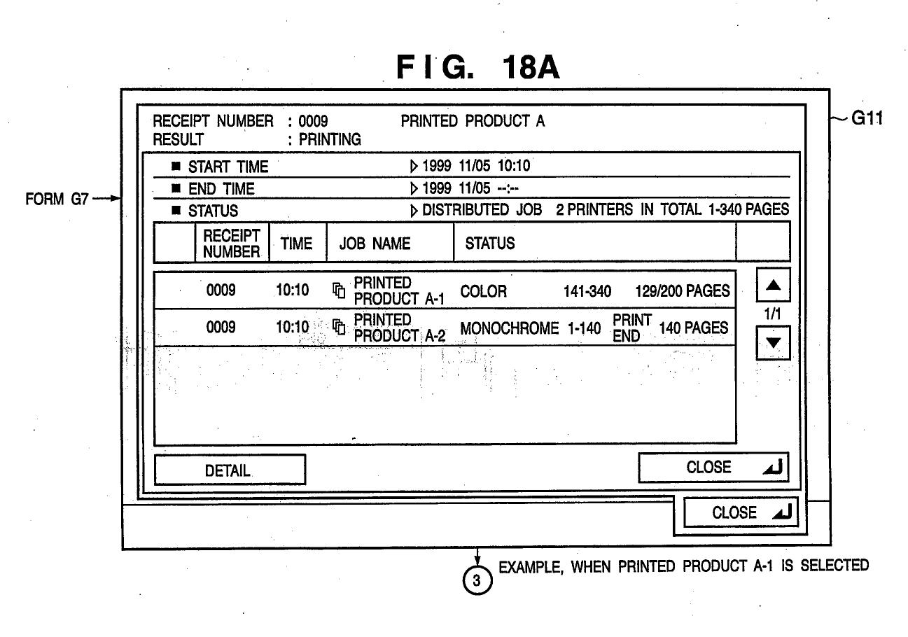

When the detail information button (e.g., detail information button 905 in FIG. 9A) is operated in, e.g., the state G7, the state G11 in FIG. 18A is generated. In addition, the state G12 in FIG. 18B is generated in accordance with a further operation.

G11: The detail window 910 (FIG. 9B) of the job of the printed product A is displayed by operating the detail information button while selecting the list line of the job of the printed product A on the list display window 1300. In addition, the detail button 914 is operated while selecting the list line of the job of a printed product A-1 in the list displayed in the detail window 910.

G12: The detail window 920 (FIG. 9C) related to the printed product A-1 is displayed by operating the detail button 914.

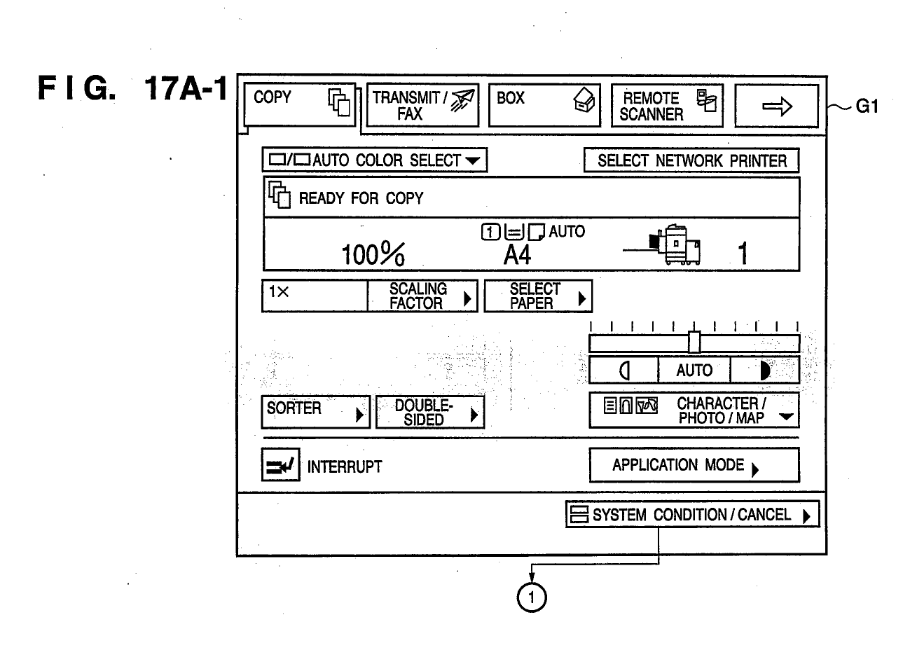

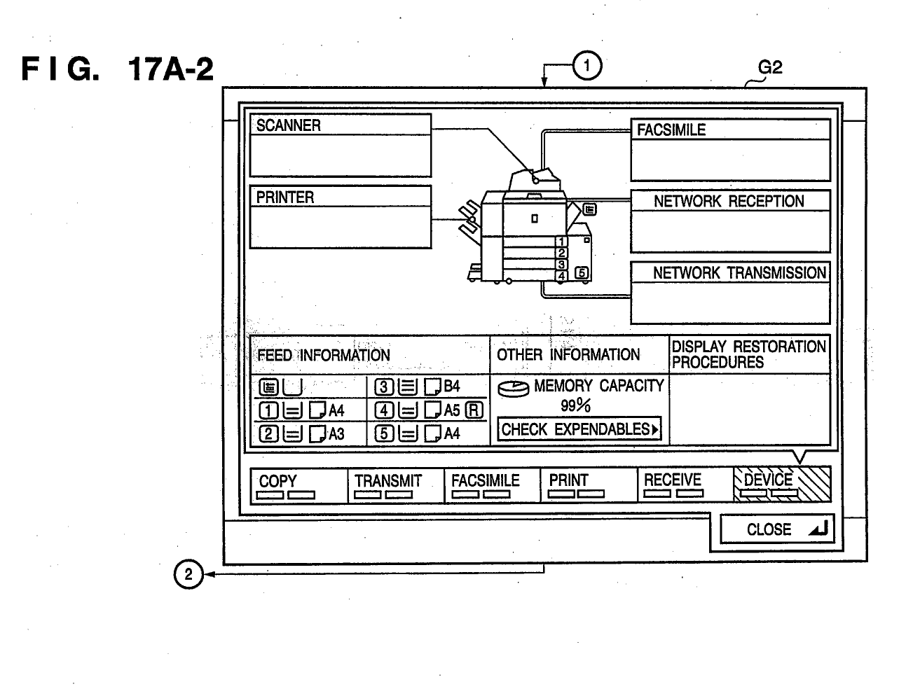

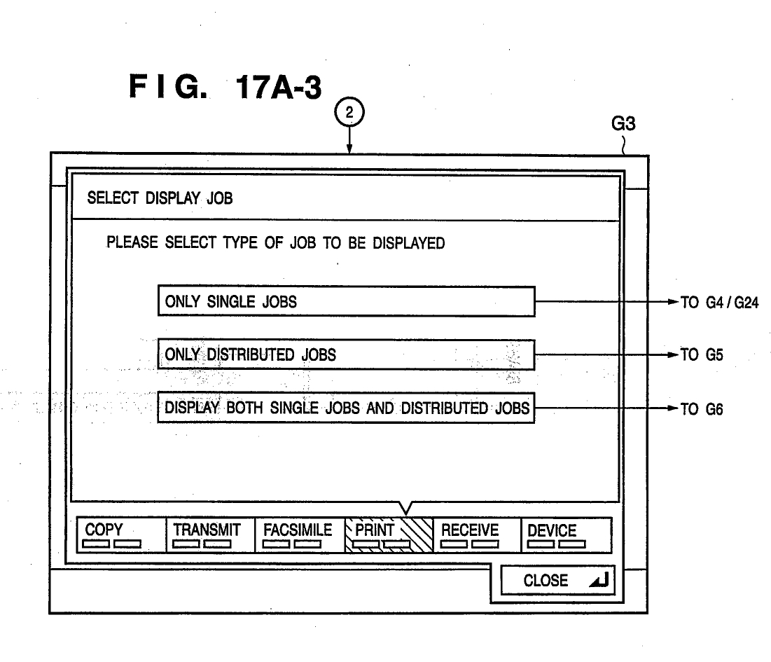

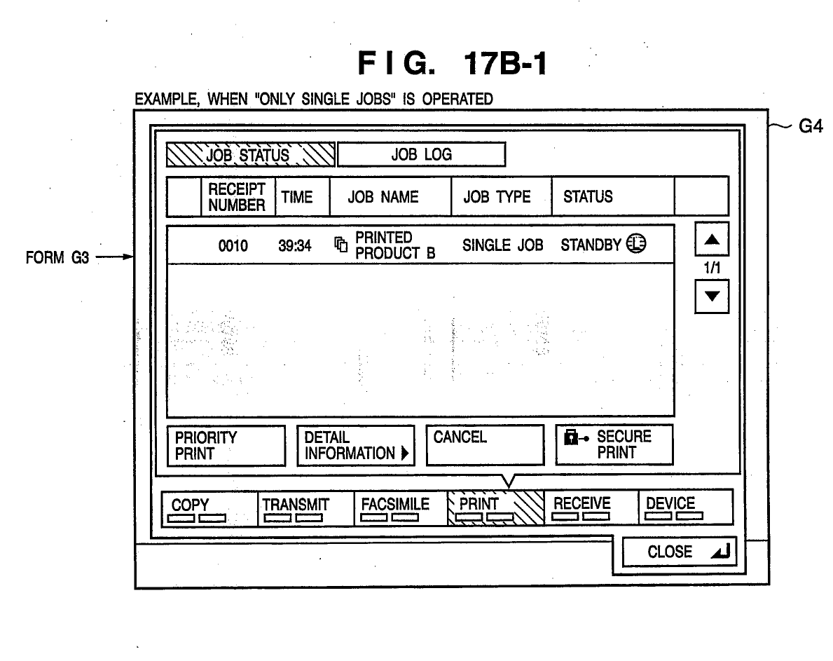

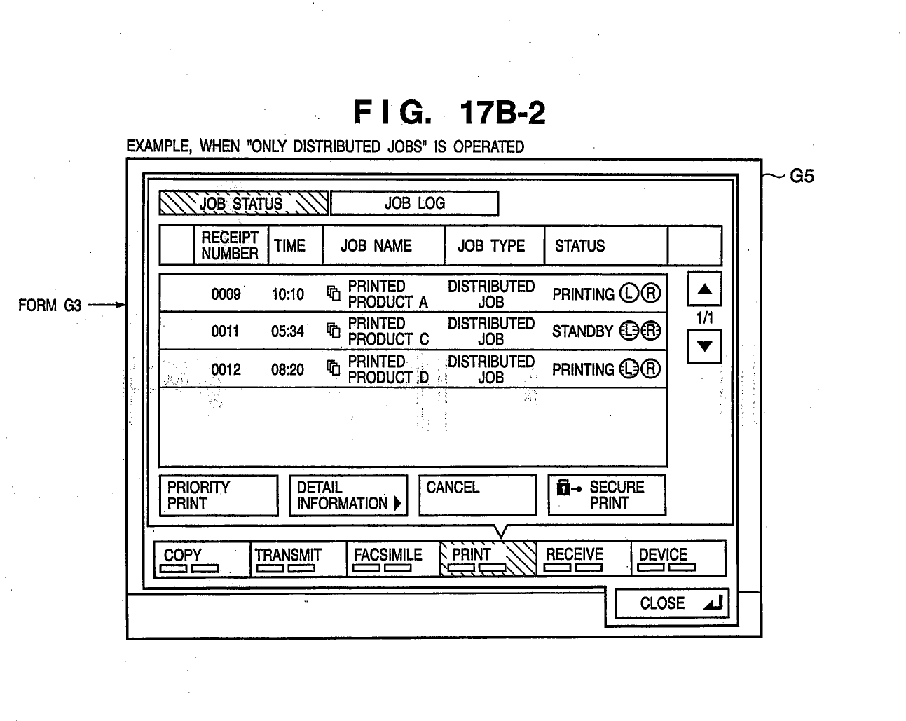

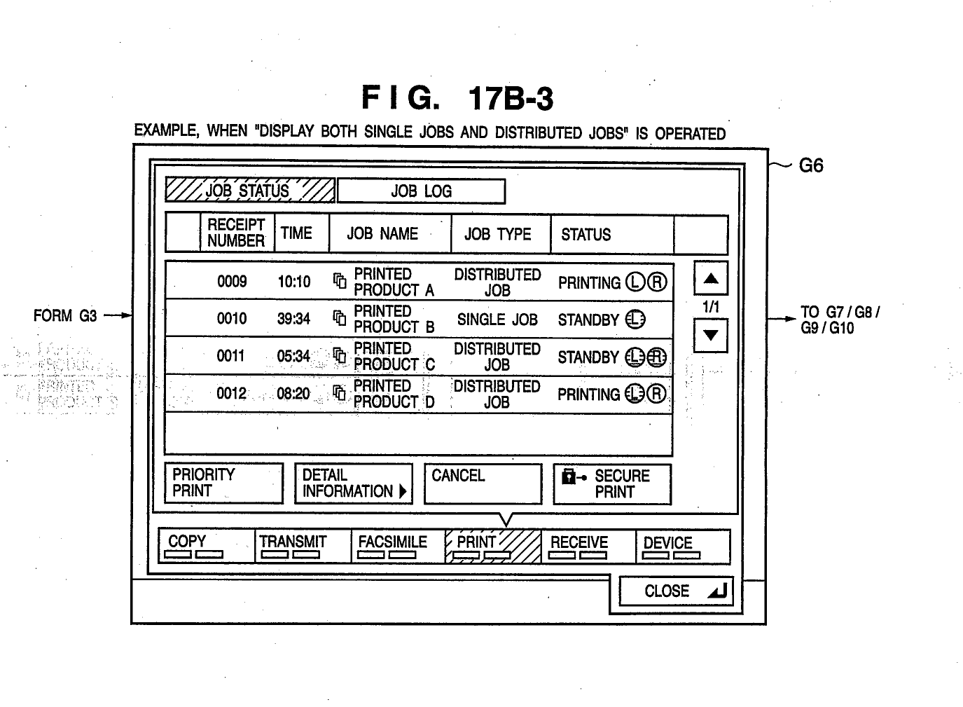

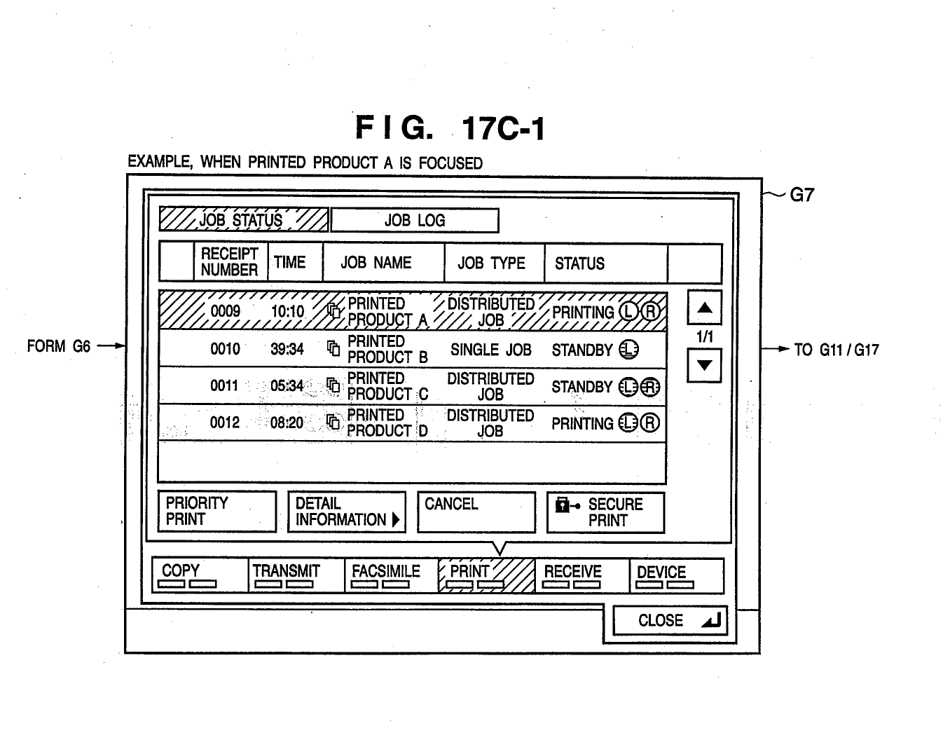

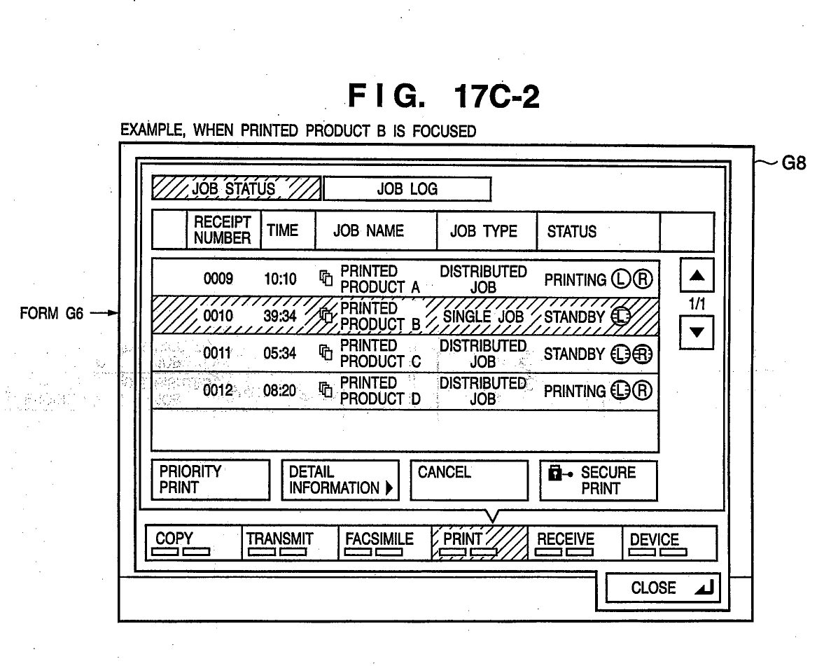

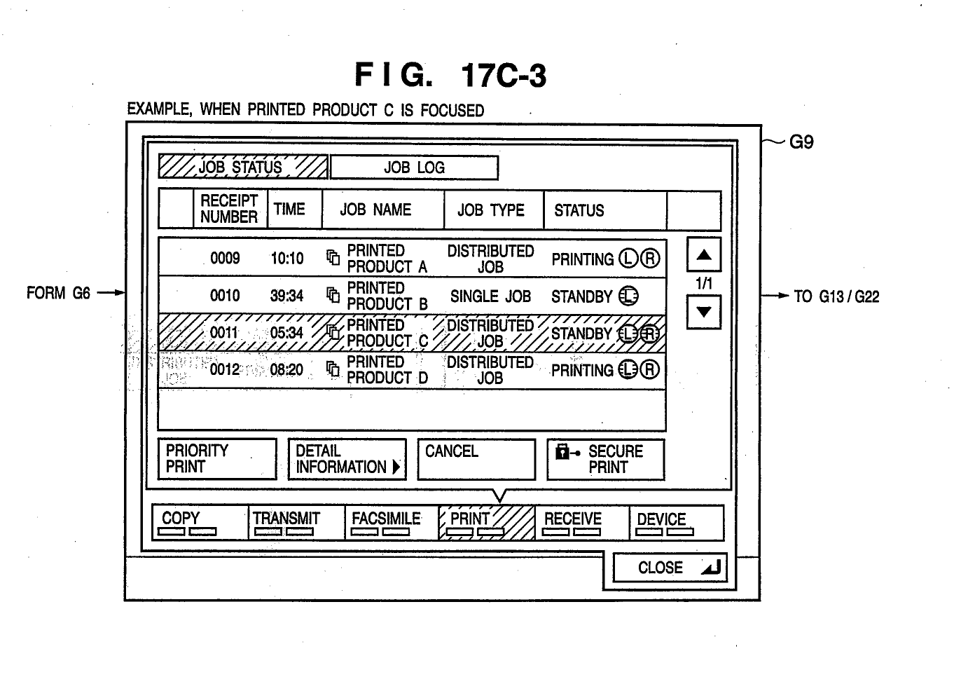

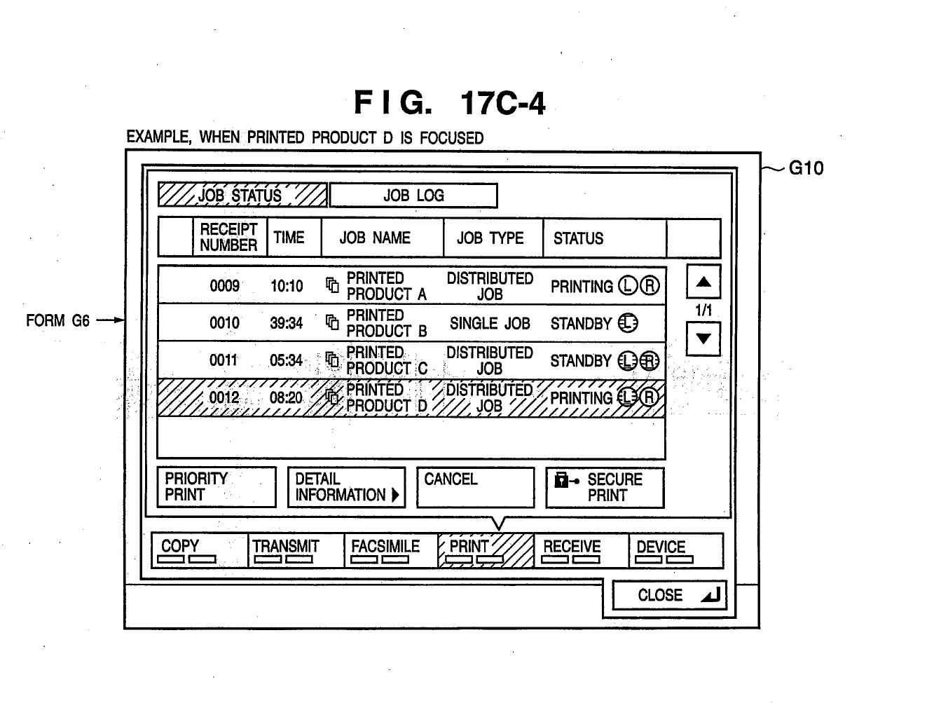

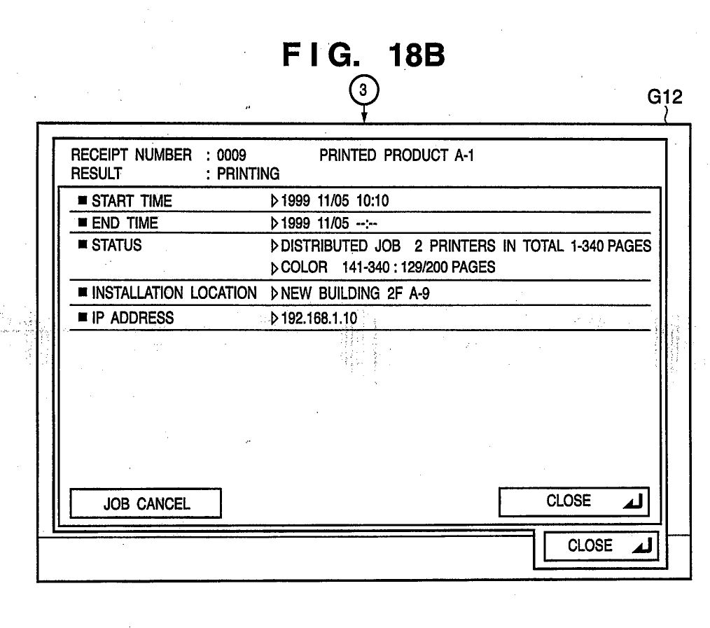

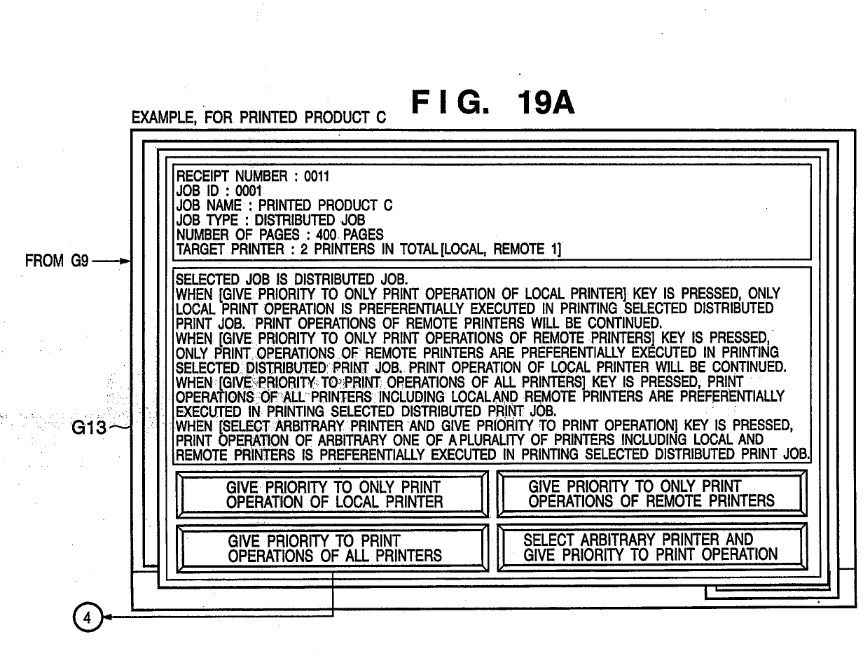

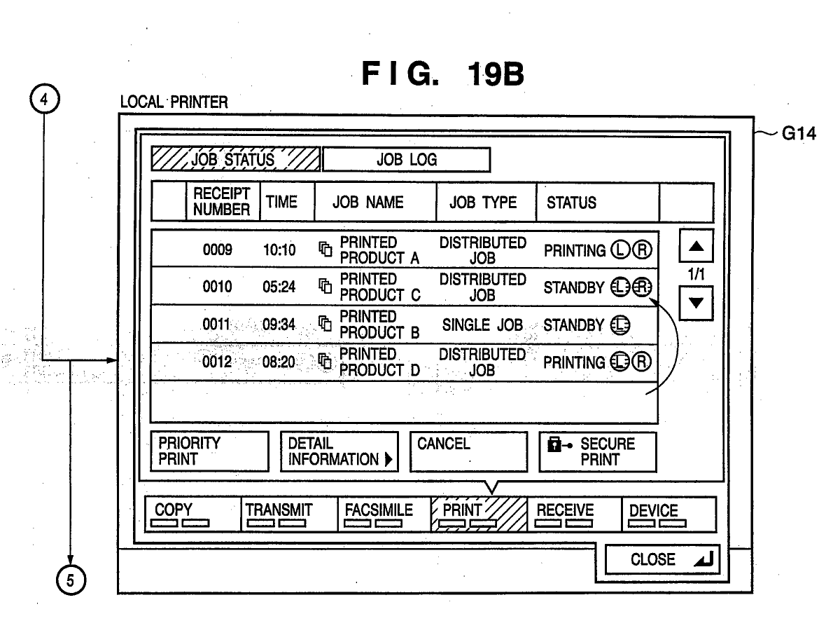

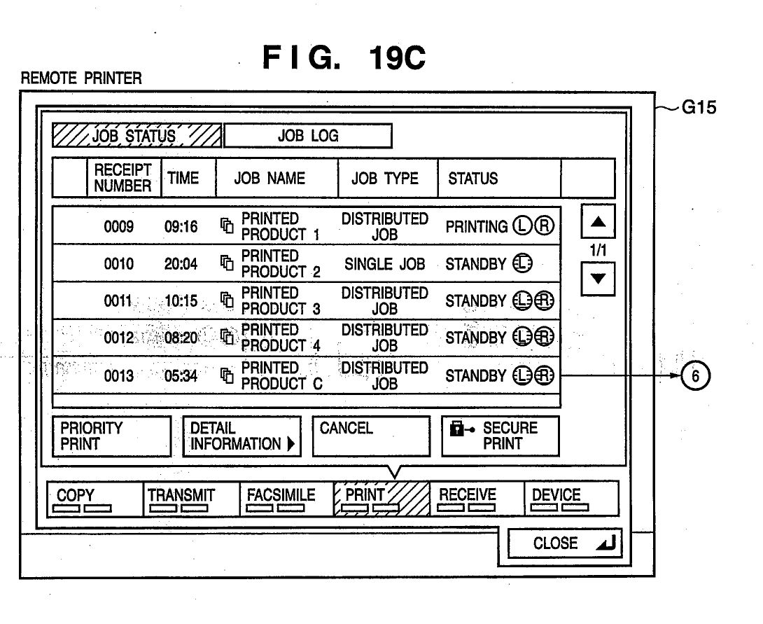

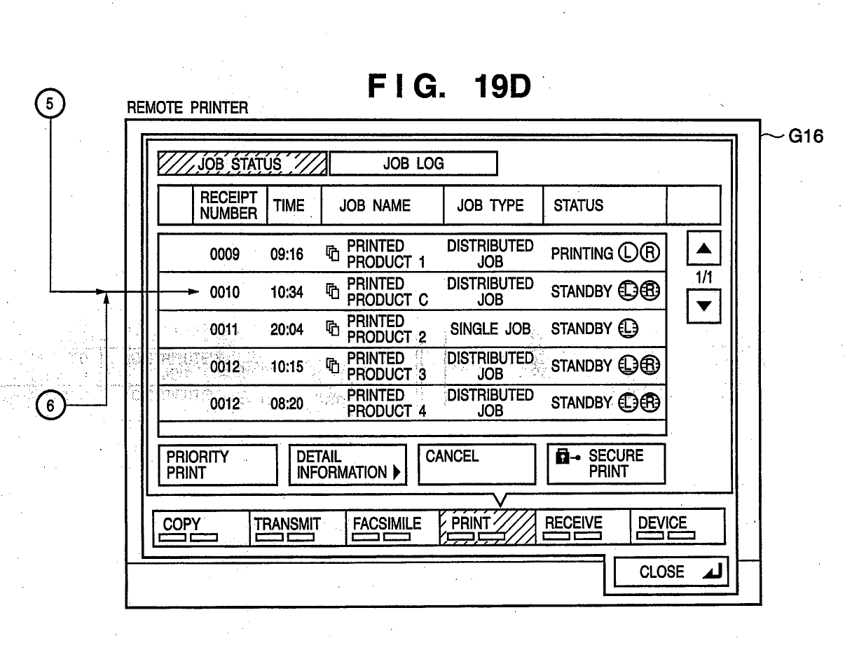

When the priority print button (e.g., priority print button 1304 in FIG. 13) is operated in, e.g., the state G9 in FIG. 17C-3, the state G13 in FIG. 19A is generated.

G13: The priority print selection window 1400 (FIG. 14) of the job of the printed product C is displayed by operating the priority print button while selecting the list line of the job of the printed product C on the list display window 1300. In addition, for example, the button 1403 (“give priority to print operations of all printers”) is operated on the priority print selection window 1400.

G14: The list line of the selected distributed job (the job of the printed product C) is raised to the uppermost position of the list lines except those during printing on the list display window 1300 of the local printer by operating the button 1403, and the display is updated (FIG. 19B).

On the other hand, the list display window 1300 on a remote printer before the operation of the state G13 is set in, e.g., the state G15 (FIG. 19C). When a notification of priority print setting of the job of the printed product C is received from the local printer, the contents are updated to the state G16 (FIG. 19D).

G16: The button 1403 is operated on the local printer. With this operation, the list line of the selected distributed job (the job of the printed product C) is raised to the uppermost position of the list lines except those during printing on the list display window 1300 of a remote printer, and the display is updated.

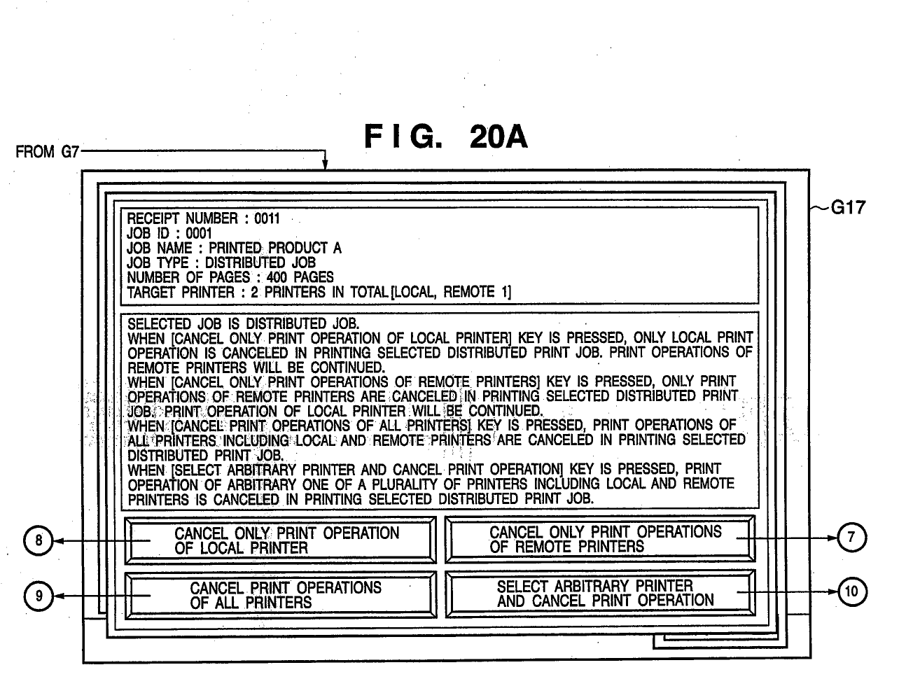

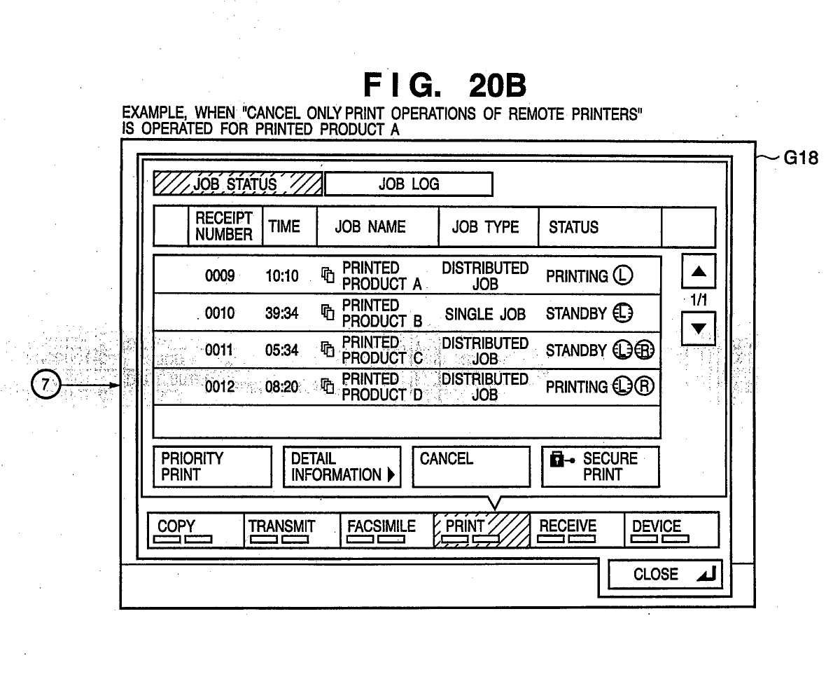

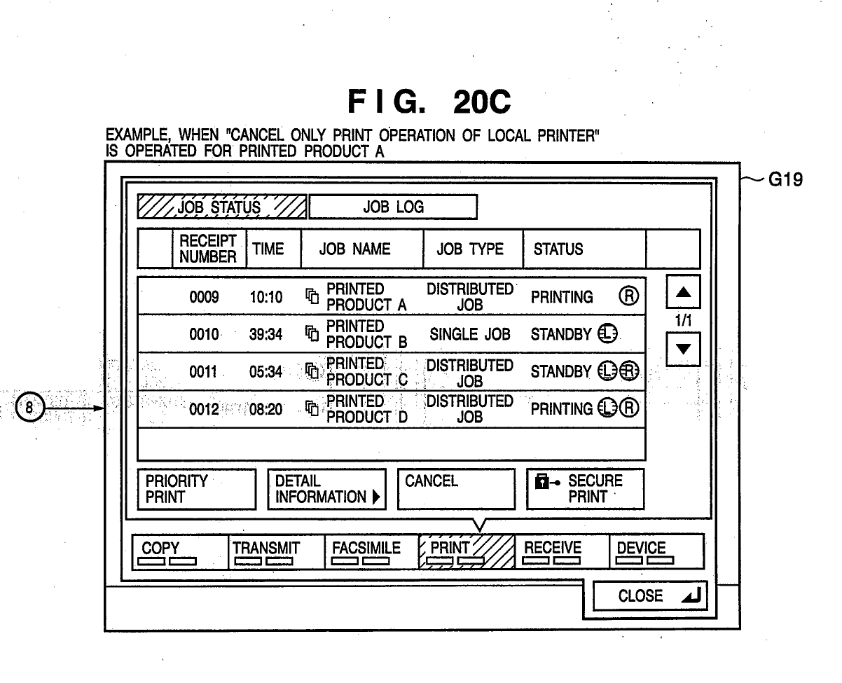

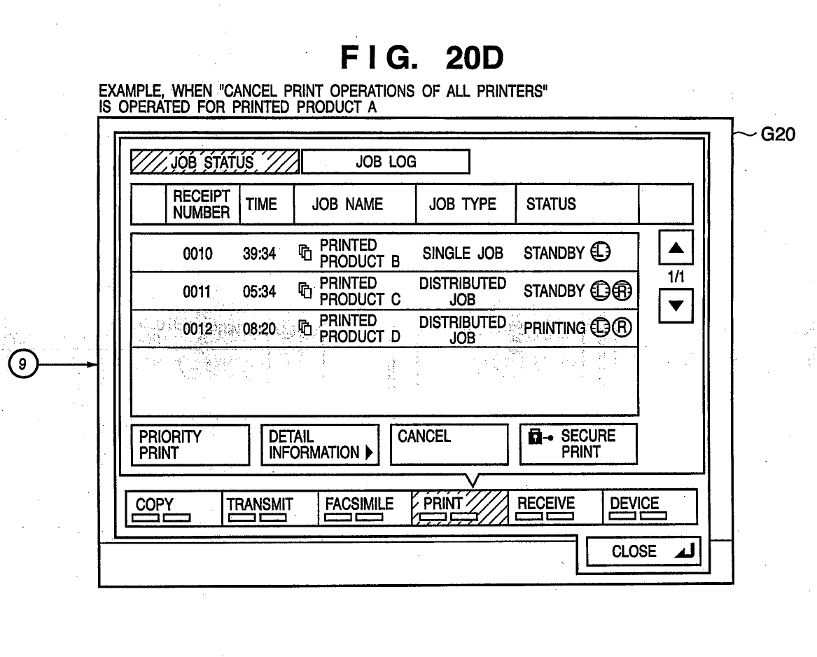

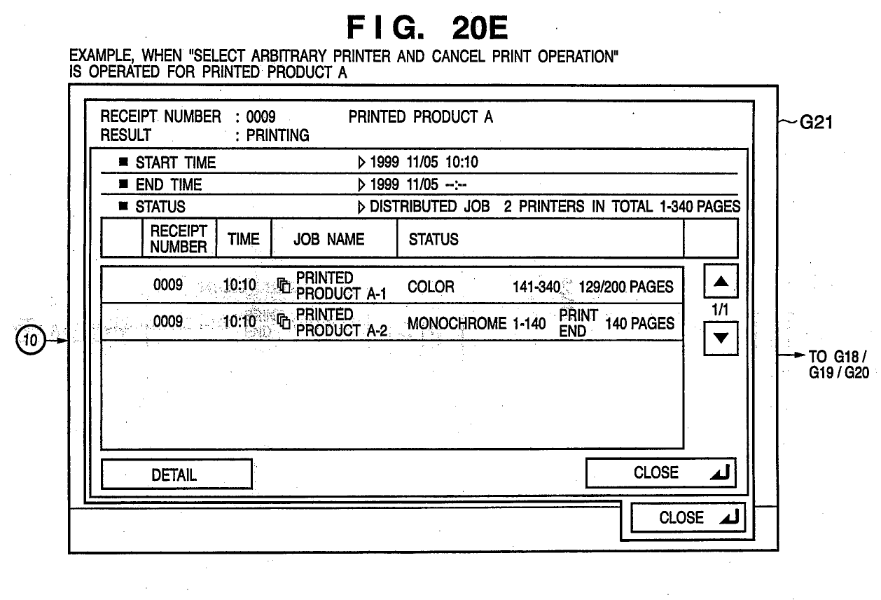

When the cancel button (e.g., cancel button 1306 in FIG. 13) is operated in, e.g., the state G7 in FIG. 17C-1, the state G17 in FIG. 20A is generated.

G17: The cancel selection window 1500 (FIG. 15) of the job of the printed product A is displayed by operating the cancel button while selecting the list line of the job of the printed product A on the list display window 1300.

G18; For example, the button 1502 (“cancel only print operations of remote printers”) is operated on the cancel selection window 1500. A cancel notification is transmitted to each remote printer related to the selected distributed job (the job of the printed product A), and the contents of the list display window 1300 of the local printer are updated (FIG. 20B). In the item “status”of the list lines of the jobs of the printed product A, icons related to the remote printers are erased.

G19: For example, the button 1501 (“cancel only print operation of local printer”) is operated on the cancel selection window 1500. A cancel notification is transmitted to the local printer related to the selected distributed job (the job of the printed product A), and the contents of the list display window 1300 of the local printer are updated (FIG. 20C). In the item “status” of the list lines of the jobs of the printed product A, an icon related to the local printer is erased.

G20: For example, the button 1503 (“cancel print operations of all printers”) is operated on the cancel selection window 1500. A cancel notification is transmitted to each of the local printer and remote printers related to the selected distributed job (the job of the printed product A), and the contents of the list display window 1300 of the local printer are updated (FIG. 20D). The list lines of the jobs of the printed product A are erased.

G21: The detail window 910 (FIG. 9B) of the selected distributed job (the job of the printed product A) is displayed by operating, e.g., the button 1504 (“select arbitrary printer and cancel print operation”) on the cancel selection window 1500 (FIG. 20E). The user can select an arbitrary one of the distributed jobs selected in the detail window and cancel the arbitrary distributed job. The state changes to one of the states G18 to G20 in accordance with the selection operation.

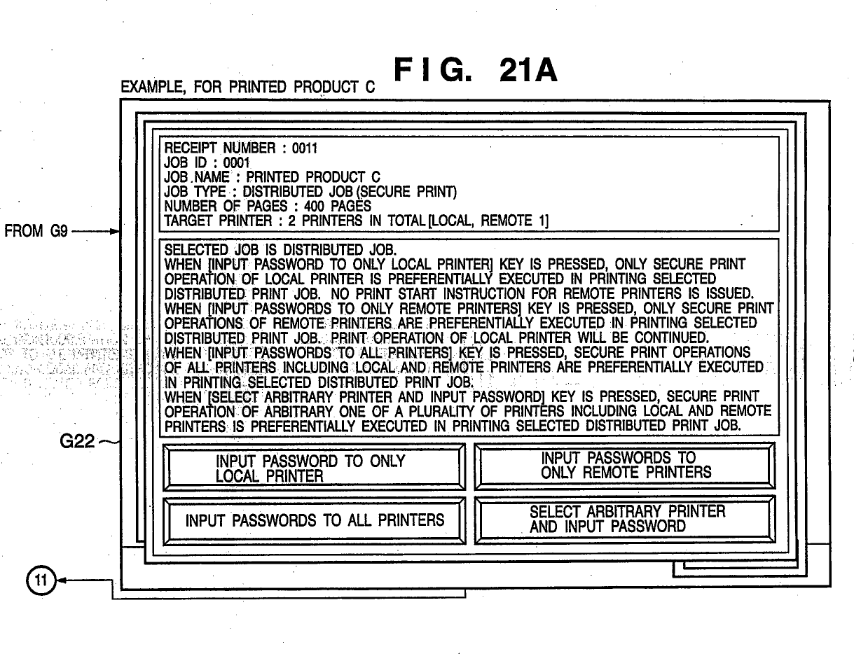

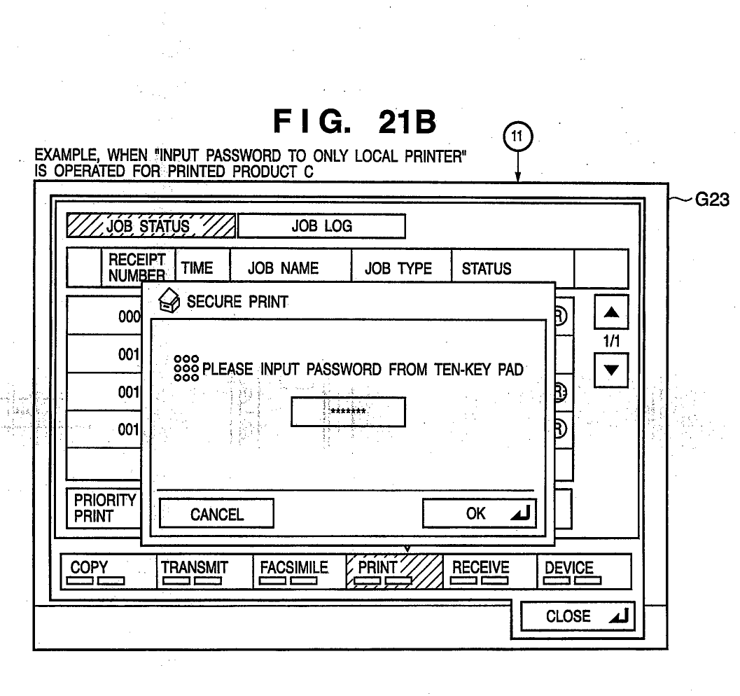

When the secure print button (e.g., secure print button 1307 in FIG. 13) is operated in, e.g., the state G9 in FIG. 17C-3, the state G22 in FIG. 21A is generated.

G22: The secure print selection window 1600 (FIG. 16) of the job of the printed product C is displayed by operating the secure print button while selecting the list line of the job of the printed product C on the list display window 1300. In addition, for example, the button 1601 (“input password to only local printer”) is operated on the secure print selection window 1600.

G23: A password input window to input the password of the local printer for the job of the printed product C is displayed by operating the button 1601 (FIG. 21B).

A change example of the operation window by various kinds of operations in a job log display state will be described below.

A change example of the operation window after the list display window 900 (FIG. 9A) is displayed by operating, e.g., the button 801 (“only single jobs”) on the display job selection window 800 (FIG. 8) in the state G3 will be described.

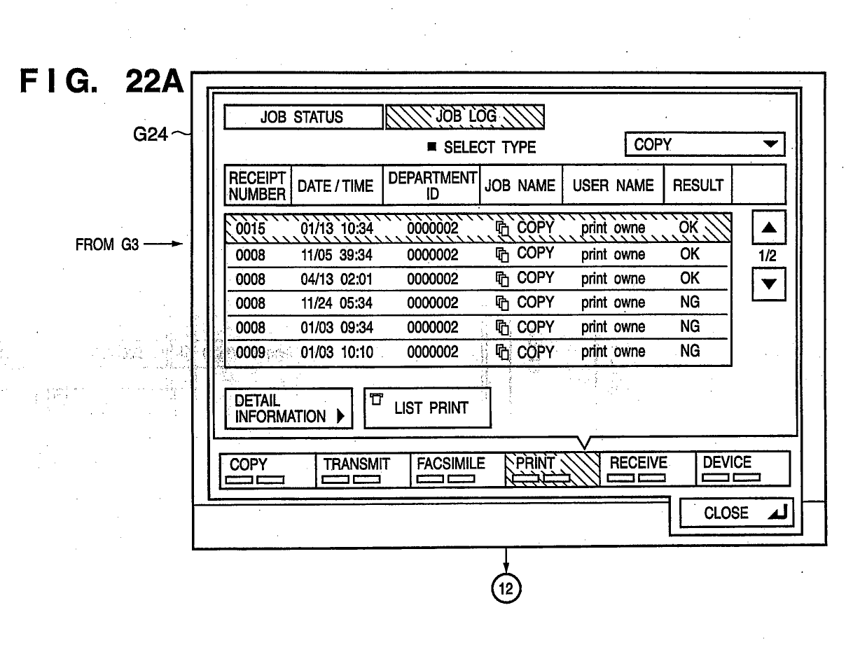

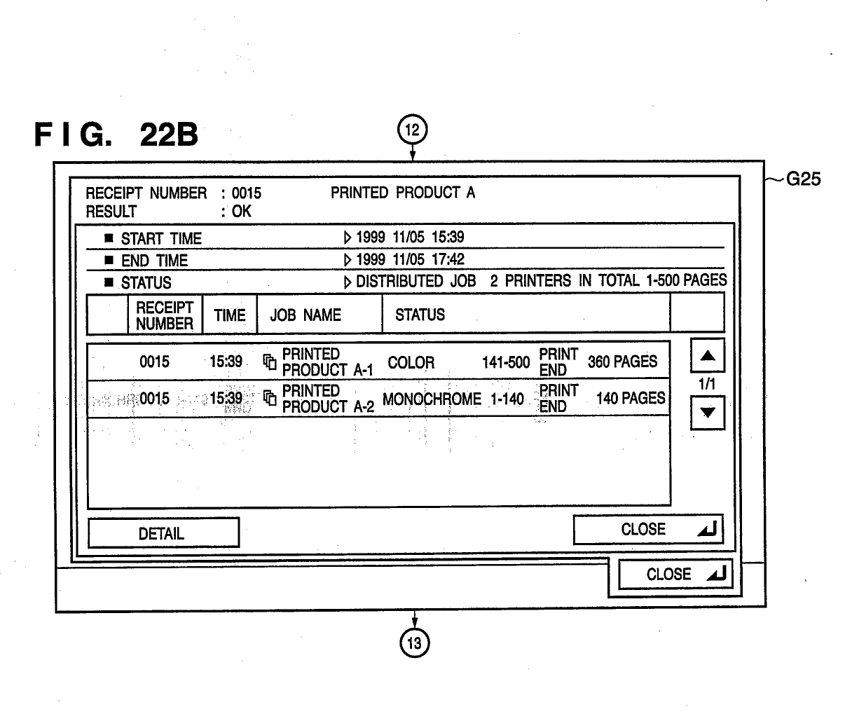

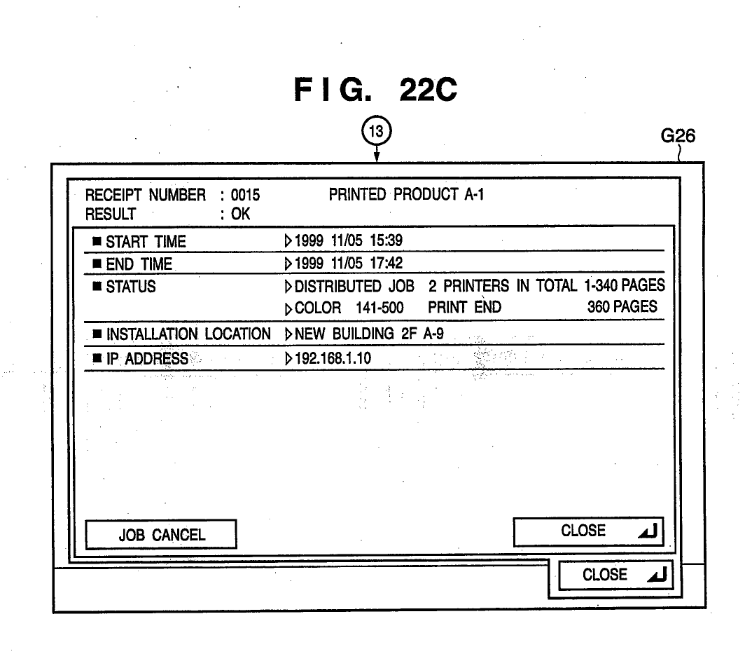

When the job log display button on the list display window 900 is operated, a state G24 in FIG. 22A is generated.

G24: The list display window 900 (FIG. 9A) is displayed by operating the button 801 (“only single jobs”) on the display job selection window 800. In addition, the list display window 1100 (FIG. 11) is displayed by operating the job log display button 902.

G25: The detail window of the job of the printed product A is displayed by operating the detail information button while selecting the list line of the job of receipt number 0015 (printed product A) on the list display window 1100 (FIG. 22B). In addition, the detail button is operated while selecting the list line of the job of the printed product A-1 in the list displayed on the detail window.

G26: The detail window of the job of the printed product A-1 is displayed by operating the detail button (FIG. 22C).

FIGS. 22A to 22C show the change example of the operation window when the button 801 (“only single jobs”) is operated. The operation window changes in the same way except the display contents even when the button 802 (“only distributed jobs”) or button 803 (“single jobs +distributed jobs”) is operated.

As described above, according to the first embodiment, in picking up distributed printed products, the operator can confirm, on only the operating image forming apparatus on which he/she is working, the processing result of a job distributed to image forming apparatuses other than his/her image forming apparatus.

In addition, since the print priority of a job issued to another image forming apparatus can be raised, or a job cancel operation can be realized on the operator's image forming apparatus, the working efficiency of the operator can be increased.

In the first embodiment, data related to various processing states are output to the operation unit 6. However, the data may be output to a printing medium through the printing unit 9. Assumed examples of the output destinations of the data related to various processing states are the operation unit 6, printing unit, and an external device on the network.

### Second Embodiment

In the first embodiment, data as a processing target is input from an image forming apparatus as a processing target. However, the present invention is not limited to this. For example, the present invention can also be applied when data is input from an external device (e.g., a PC 102 in FIG. 1).

### Third Embodiment

In the first embodiment, distributed processing of a job is implemented by a controller (job control unit) in an image forming apparatus. However, the present invention is not limited to this. For example, distributed processing of a job can also be implemented by an external controller (e.g., a PC 107 with a server function in FIG. 1) capable of implementing the same function as the job control unit.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

This application claims the benefit of Japanese Application No. 2005-104359, filed Mar. 31, 2005, which is hereby incorporated by reference herein in its entirety.

What is claimed is:

1. An image forming apparatus capable of receiving a job in a distributed print mode in which print processing is executed by distributing the print processing to a plurality of image forming apparatuses and a job in a single print mode in which print processing is executed by one image forming apparatus, comprising:
storage means for storing and managing job information about a received job; and
output control means for controlling output of information of the received jobs on the basis of the job information stored in said storage means so as to make the information distinguishable between the job in the distributed print mode and the job in the single print mode.

2. The apparatus according to claim 1, wherein said output control means outputs, to a display unit, the information of the received jobs on the basis of the job information stored in said storage means so as to make the information distinguishable between the job in the distributed print mode and the job in the single print mode.

3. The apparatus according to claim 1, wherein said output control means outputs, to a display unit, a list of the information of the received jobs on the basis of the job information stored in said storage means so as to make the information distinguishable between the job in the distributed print mode and the job in the single print mode.

4. The apparatus according to claim 1, wherein said output control means outputs, to a single window displayed on a display unit, the information of the received jobs on the basis of the job information stored in said storage means so as to make the information distinguishable between the job in the distributed print mode and the job in the single print mode.

5. The apparatus according to claim 1, wherein said output control means has
a first output mode in which, of the received jobs, information of only the job in the single print mode is output on the basis of the job information stored in said storage means;
a second output mode in which, of the received jobs, information of only the job in the distributed print mode is output on the basis of the job information stored in said storage means; and
a third output mode in which, of the received jobs, pieces of information of the jobs in the single print mode and distributed print mode are output distinguishably on the basis of the job information stored in said storage means.

6. The apparatus according to claim 5, further comprising instruction means for instructing output in the first output mode, the second output mode, and the third output mode.

7. The apparatus according to claim 1, further comprising execution means for executing, in accordance with designated processing contents, processing of a job selected on the basis of the job information output by said output control means.

8. The apparatus according to claim 7, wherein said execution means executes, on the basis of selected processing contents, one of
cancel processing of canceling a processing operation of the selected job,
priority processing of giving a priority to processing of the selected job over remaining jobs, and
authentication processing of executing the processing of the selected job on the basis of authentication.

9. The apparatus according to claim 8, further comprising selection means for selecting the job as an execution target by said execution means and the processing contents.

10. The apparatus according to claim 9, wherein when the job as the execution target by said execution means is the job in the distributed print mode, said selection means is capable of selecting whether to perform execution by said execution means for each of the image forming apparatuses of a distribution source and distribution destination of the job.

11. The apparatus according to claim 10, wherein said selection means is capable of selecting, for the job in the distributed print mode, one of
a first selection mode in which only the image forming apparatus of the distribution source of the job is selected as the execution target by said execution means,
a second selection mode in which only the image forming apparatus of the distribution destination of the job is selected as the execution target by said execution means,
a third selection mode in which all the image forming apparatuses of the distribution source and distribution destination of the job are selected as the execution target by said execution means, and
a fourth selection mode in which an image forming apparatus to process a desired one of a plurality of partial jobs included in the job is selected as the execution target by said execution means.

12. An image forming apparatus capable of receiving a job in a distributed print mode in which print processing is executed by distributing the print processing to a plurality of image forming apparatuses and a job in a single print mode in which print processing is executed by one image forming apparatus, comprising:
storage means for storing and managing job information about a received job; and
execution means for executing, in accordance with designated processing contents, processing of a job selected on the basis of the job information stored in said storage means,
said execution means comprising, for the job in the distributed print mode,
a first selection mode in which only the image forming apparatus of a distribution source of the job is selected as an execution target by said execution means,
a second selection mode in which only the image forming apparatus of a distribution destination of the job is selected as the execution target by said execution means,
a third selection mode in which all the image forming apparatuses of the distribution source and distribution destination of the job are selected as the execution target by said execution means, and
a fourth selection mode in which an image forming apparatus to process a desired one of a plurality of partial jobs included in the job is selected as the execution target by said execution means.

13. The apparatus according to claim 12, wherein said execution means executes, on the basis of selected processing contents, one of
cancel processing of canceling a processing operation of the selected job,
priority processing of giving a priority to processing of the selected job over remaining jobs, and
authentication processing of executing the processing of the selected job on the basis of authentication.

14. The apparatus according to claim 1, further comprising:
the plurality of image forming apparatuses and an external device, which are connected through a network;
reading means for reading a document; and
input means for receiving and inputting the job through one of the image forming apparatuses, said external device, and said reading means connected through the network.

15. An image forming system formed by mutually connecting, through a network, a plurality of image forming apparatuses each capable of receiving a job in a distributed print mode in which print processing is executed by distributing the print processing to a plurality of image forming apparatuses and a job in a single print mode in which print processing is executed by one image forming apparatus, wherein
each of the image forming apparatuses comprises:
storage means for storing and managing job information about a received Job;
output control means for controlling output of information of the received jobs on the basis of the job information stored in said storage means so as to make the information distinguishable between the job in the distributed print mode and the job in the single print mode; and
notification means for sending an update notification of the job information of the job between the image forming apparatuses of a distribution source and distribution destination of the job in the distributed print mode.

16. An image forming system formed by mutually connecting, through a network, a plurality of image forming apparatuses each capable of receiving a Job in a distributed print mode in which print processing is executed by distributing the print processing to a plurality of image forming apparatuses and a job in a single print mode in which print processing is executed by one image forming apparatus, wherein
each of the image forming apparatuses comprises:
storage means for storing and managing job information about a received job;
execution means for executing, in accordance with designated processing contents, processing of a job selected on the basis of the job information stored in said storage means; and
notification means for sending an update notification of the job information of the job between the image forming apparatuses of a distribution source and distribution destination of the job in the distributed print mode,
said execution means comprising, for the job in the distributed print mode,
a first selection mode in which only the image forming apparatus of the distribution source of the job is selected as an execution target by said execution means,
a second selection mode in which only the image forming apparatus of the distribution destination of the job is selected as the execution target by said execution means,
a third selection mode in which all the image forming apparatuses of the distribution source and distribution destination of the job are selected as the execution target by said execution means, and
a fourth selection mode in which an image forming apparatus to process a desired one of a plurality of partial jobs included in the job is selected as the execution target by said execution means.

17. A control method of an image forming apparatus capable of receiving a job in a distributed print mode in which print processing is executed by distributing the print processing to a plurality of image forming apparatuses and a job in a single print mode in which print processing is executed by one image forming apparatus, comprising:
a storage step of storing job information about a received job in a storage unit to store and manage the job information; and
an output control step of controlling output of information of the received jobs on the basis of the job information stored in the storage unit so as to make the information distinguishable between the job in the distributed print mode and the job in the single print mode.

18. A control method of an image forming apparatus capable of receiving a job in a distributed print mode in which print processing is executed by distributing the print processing to a plurality of image forming apparatuses and a job in a single print mode in which print processing is executed by one image forming apparatus, comprising:
a storage step of storing job information about a received job in a storage unit to store and manage the job information; and
an execution step of executing, in accordance with designated processing contents, processing of a job selected on the basis of the job information stored in the storage unit,
the execution step comprising, for the job in the distributed print mode,
a first selection mode in which only the image forming apparatus of a distribution source of the job is selected as an execution target in the execution step,
a second selection mode in which only the image forming apparatus of a distribution destination of the job is selected as the execution target in the execution step,
a third selection mode in which all the image forming apparatuses of the distribution source and distribution destination of the job are selected as the execution target in the execution step and
a fourth selection mode in which an image forming apparatus to process a desired one of a plurality of partial jobs included in the job is selected as the execution target in the execution step.

19. A program comprising a program code for causing a computer to execute an image forming apparatus control method of claim 17.

20. A storage medium for storing a computer-readable program of claim 19.

21. A program comprising a program code for causing a computer to execute an image forming apparatus control method of claim 18.

22. A storage medium for storing a computer-readable program of claim 21.
